(19) United States
(12) Patent Application Publication
(10) Pub. No.: US 2010/0308690 A1
(43) Pub. Date: Dec. 9, 2010

(54) MEMS PIEZOELECTRIC ACTUATORS

(76) Inventors: Luke Currano, Columbia, MD (US); Danny Gee, Severn, MD (US)

Correspondence Address: U S ARMY RESEARCH LABORATORY;ATTN: RDRL-LOC-I, 2800 POWDER MILL RD, ADELPHI, MD, 20783-1197, US

(21) Appl. No.: 12/480,434

(22) Filed: Jun. 8, 2009

(51) Int. Cl. H02N 2/12

(52) U.S. Cl. 310/333

(57) ABSTRACT

A rotational actuator includes a plurality of actuation beams each having an offset longitudinal axis with respect to one another; and a coupler connecting the plurality of actuation beams to one another, wherein the coupler is connected to each individual actuation beam at a position where connection of the coupler to other actuation beams causes the longitudinal axis of each actuation beam to be offset with respect to one another, wherein the plurality of actuation beams are lengthened or shortened to cause a moment about the coupler causing rotation of a point in the rotational actuator. The rotational actuator includes an amplification beam connected to the coupler such that the longitudinal axis of the amplification beam is substantially perpendicular to the longitudinal axes of the plurality of actuation beams. Additionally, the rotational actuator includes a resistant spring member connected to the amplification beam. The actuation beams can be thermally or piezoelectrically induced.

### BACKGROUND

1. Technical Field

The embodiments herein generally relate to microelectromechanical systems (MEMS), and, more particularly, to MEMS actuators.

2. Description of the Related Art

The vast majority of MEMS actuators generate translational motion. A few rotational actuators have been documented in the development of micro-robotics, locomotives, and other biologically-inspired devices. While piezoelectric materials are scrutinized for limited strain and fabrication complexities, they exhibit excellent characteristics that are attractive for MEMS actuators. Piezoelectric actuators have demonstrated wide bandwidths, high sensitivity, and large stroke forces. Also with high power densities, piezoelectric actuators generally exhibit the most efficient transduction mode. Lead zirconate titanate (PZT) is a well-studied piezoelectric material that is used in MEMS for its attractive thin film properties. Previous research in piezoelectric rotational actuation has been largely limited to optical microstages that operate with non-planar behavior. As the longitudinal piezoelectric coefficient for PZT is nearly double the value of the transverse coefficient, it is convenient to develop out-of-plane actuators. This presents a unique challenge for applications that require in-plane actuation.

Historically, MEMS actuators have relied on simplified designs, focusing on in-plane, one-dimensional, linear deflections. However, as the microsystems industry continues to mature, more complex systems are requiring large displacement, high-force actuators with smaller chip real estate, which typically cannot be achieved by the limitations of previous designs. The performance of a MEMS actuator is highly related to its method of actuation. Electrostatic actuators are relatively simple in design and are easily integrated into circuits but typically require very high voltages. Conversely, magnetic actuators tend to require high currents and are generally inefficient in thin film form. Piezoelectrics are efficient and have high energy densities; however, they are difficult to design for in-plane movement and integration with complementary metal oxide semiconductor (CMOS) processing.

Thermal actuators are typically regarded as inefficient while yielding either high forces and small displacements or high displacements and small forces. Moreover, thermal actuators are often dismissed because of high power consumption relative to many electrostatic and piezoelectric actuators, but they do have certain advantages. They are useful in some MEMS devices because they can provide large forces and large displacements simultaneously. They also require relatively low voltage (often less than 10V), especially as compared to electrostatic actuators. The focus of most research and application of thermal actuators has primarily been on two types: (1) bent beam or “chevron” or v-beam actuators (so called because of their shape), and (2) hot arm/cold arm or u-beam actuators. Bent beam actuators supply very large forces (typically hundreds of micronewtons to a few millinewtons) with linear deflections up to about 30 μm, but have high power consumption. Hot arm/cold arm actuators are generally limited to small forces (less than 10 μN) but can supply relatively large free displacement along an arc (up to 50 μm).

### SUMMARY

The present invention is composed of a series of embodiments having a rotational actuator formed by a plurality of actuation beams each having an offset longitudinal axis with respect to one another. Another element of the present invention is a coupling joint connecting the plurality of actuation beams to one another. The coupling joint is connected to each individual actuation beam at a position where connection of the coupling joint to other actuation beams causes the longitudinal axis of each actuation beam to be offset with respect to one another. During operation the plurality of actuation beams are lengthened or shortened to cause a moment about the coupling joint causing rotation of a point in the rotational actuator. An amplification beam is included and contemplated by the inventors for several embodiments of the present invention. Furthermore, the rotational actuator includes in at least one embodiment an amplification beam connected to the coupling joint such that the longitudinal axis of the amplification beam is substantially perpendicular to the longitudinal axes of the plurality of actuation beams. Additionally, the rotational actuator comprises in at least one embodiment a resistant spring member connected to the amplification beam.

In one embodiment the plurality of actuation beams are substantially parallel to one another along the longitudinal axis and oriented to be angled to one another. During operation, the plurality of actuation beams are lengthened or shortened to generate the moment about the coupling joint causing the amplification beam to rotate. Causing the beams to lengthen induces a tensile stress in the beams because the anchor points are fixed. This causes undesired buckling of the actuator beams if the tensile stress is high enough. The shortening of the actuation beams increases the stability of the actuator by placing the beams under tension rather than compression. Tension is not susceptible to beam buckling, so this mode of actuation is preferred. Likewise, the plurality of actuation beams improves the actuator stability by distributing the energizing forces, thereby limiting beam buckling. Furthermore, the plurality of actuation beams comprise any of thermal-sensitive materials that are induced to lengthen or shorten the plurality of actuation beams and piezoelectric materials that are induced to lengthen or shorten the plurality of actuation beams. The rotational actuator in at least one embodiment is formed of support structures attached to the plurality of actuation beams. The rotation provides reset latching for a microelectromechanical system (MEMS) sensor. Additionally, the plurality of actuation beams in at least one embodiment is formed to create microgrippers and microtweezers. Also, the plurality of actuation beams is electrically conductive. Furthermore, an offset amount between the longitudinal axes of the plurality of actuation beams in at least one embodiment is greater than a width of each individual actuation beam. Alternatively, an offset amount between the longitudinal axes of the plurality of actuation beams is less than a width of each individual actuation beam.

A method of providing rotational actuation of a microelectromechanical system (MEMS) device includes providing a plurality of actuation beams; connecting a coupler to the plurality of actuation beams, wherein the coupler is connected to each individual actuation beam at a position where connection of the coupler to other actuation beams causes a longitudinal axis of each actuation beam to be offset with respect to one another, this in turn acts to energize the plurality of actuation beams to cause a moment about the coupler causing rotation of a point in the MEMS device.

In one embodiment, a method for fabricating the piezoelectric actuation beams and the amplification beam is presented. The pluralities of beams are formed by surface micromachining a silicon-on-insulator wafer. The energizing piezoelectric thin film is deposited using sol-gel lead zirconate titanate, although other piezoelectric materials and deposition techniques are possible. The actuator is patterned using ion milling and other semiconductor processing techniques. Afterwards, the beam sidewalls are protected with spuncast photoresist and the final device is released with vapor-phase etching, which undercuts into the bulk silicon handle layer.

The method in at least one embodiment of the present invention includes but is not limited to connecting an amplification beam to the coupler such that the longitudinal axis of the amplification beam is substantially perpendicular to the longitudinal axes of the plurality of actuation beams. The method also includes but is not limited to connecting a resistant spring member to the amplification beam.

In yet another embodiment, a microelectromechanical system (MEMS) device is formed to include at least two anchored actuation beams arranged in series with one another, wherein each beam comprises an offset longitudinal axis with respect to other actuation beams. A coupling joint connects the at least two actuation beams to one another in an offset configuration. A cantilevered amplification beam operatively connected to the coupling joint. The longitudinal axis of the amplification beam is substantially perpendicular to the longitudinal axes of the at least two actuation beams and a resistant spring member operatively connected to the amplification beam. The actuation beams are lengthened or shortened to cause a moment about the coupling joint causing rotation of the amplification beam. The actuation beams are formed from any of the group of thermal-sensitive materials that are induced to lengthen or shorten and piezoelectric materials that are induced to lengthen or shorten.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a schematic diagram of a rotational actuator according to an embodiment herein;

FIG. 2 illustrates a schematic diagram of the rotational actuator of FIG. 1 undergoing rotational displacement according to an embodiment herein;

FIGS. 3A through 5 illustrate schematic diagrams of rotational actuators according other embodiments herein;

FIGS. 6A through 6H illustrate schematic diagrams of successive steps for manufacturing an actuator according to an embodiment herein;

FIG. 7 illustrates a graphical representation of deflection graphs for four 5 μm-wide actuators with various resisting spring widths;

FIG. 8 illustrates a graphical representation comparing the effectiveness between piezoelectric and electrothermal rotational actuators;

FIG. 9A illustrates a graphical representation of a torque-rotation graph for actuators of various widths at a constant voltage;

FIG. 9B illustrates a graphical representation of a force-displacement graph for actuators of various widths at a constant voltage;

FIG. 10 illustrates a top view of the actuator of FIG. 4 according to an embodiment herein;

FIG. 11A illustrates a clamped-pinned beam geometry of an actuator undergoing bending;

FIG. 11B illustrates a clamped-pinned beam with overextension geometry of an actuator undergoing bending;

FIG. 12A illustrates a graphical representation of a linear spring constant graph for a 7 μm-wide, 500 μm long actuator at 12.9 mA;

FIG. 12B illustrates a graphical representation of a torsional spring constant graph for a 7 μm-wide, 500 μm long actuator at 12.9 mA;

FIG. 13A illustrates a graphical representation of the maximum deflection vs. spring constant for a free actuator;

FIG. 13B illustrates a graphical representation of the maximum deflection vs. spring constant for a latched actuator;

FIG. 14A illustrates a graphical representation of the power consumption-displacement for a 400 μm-long, 5 μm-wide actuator beam;

FIG. 14B illustrates a graphical representation of the power consumption-displacement for a 400 μm-long, 7 μm-wide actuator beam;

FIG. 14C illustrates a graphical representation of the power consumption-displacement for a 400 μm-long, 10 μm-wide actuator beam;

FIG. 15A illustrates a graphical representation of the power consumption-force for a 5 μm-wide beam and a 10 μm-wide latch;

FIG. 15B illustrates a graphical representation of the power consumption-force for a 7 μm-wide beam and a 10 μm-wide latch;

FIG. 15C illustrates a graphical representation of the power consumption-force for a 10 μm-wide beam and a 10 μm-wide latch;

FIG. 15D illustrates a graphical representation of the power consumption-force for a 10 μm-wide beam and a 20 μm-wide latch;

FIG. 16A illustrates a graphical representation of the peak force efficiency over various actuator dimensions;

FIG. 16B illustrates a graphical representation of the peak deflection efficiency for free actuators over various actuator dimensions;

FIG. 17A illustrates a graphical representation comparing a model free deflection prediction with experimental data for actuators with L=400 μm, with varying actuator beam widths;

FIG. 17B illustrates a graphical representation comparing a model free deflection prediction with experimental data for actuators with w=7 μm, with varying actuator beam lengths;

FIG. 18 illustrates a graphical representation illustrating moment/angular deflection relationships for 400 μm long rotational actuators of varying width;

FIG. 19 illustrates a graphical representation illustrating measured and calculated torsional spring constants;

FIG. 20 illustrates a graphical representation illustrating force/deflection relationships for 400 μm long rotational actuators of varying width;

FIG. 21 illustrates a graphical representation illustrating free deflection for v-beam, u-beam, and rotational thermal actuators;

FIG. 22 illustrates a graphical representation illustrating vacuum and atmosphere temperature profiles for an actuator with L=400 μm, w=5 μm, with an applied current of 5 mA;

FIG. 23 illustrates a graphical representation comparing actuator free deflections in vacuum and atmosphere;

FIG. 24 illustrates a graphical representation illustrating the frequency response of offset beam actuators in air for L=400 μm, with various widths; and

FIG. 25 is a flow diagram illustrating a method according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

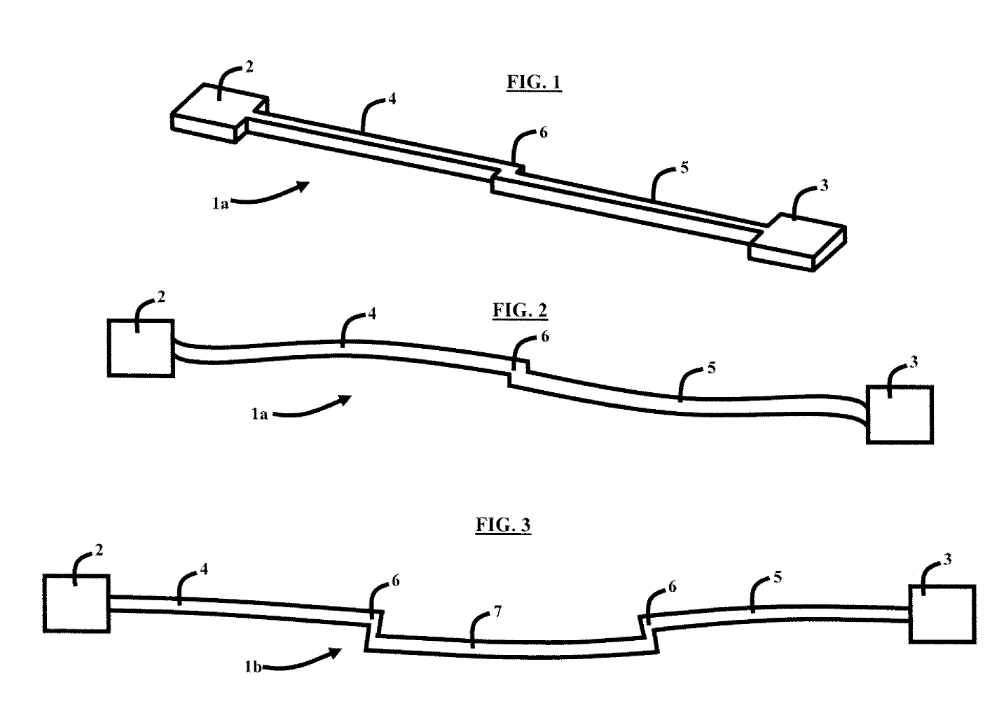

The embodiments herein provide an offset rotational actuator. Referring now to the drawings, and more particularly to FIGS. 1 through 25, where similar reference characters denote corresponding features consistently throughout the figures, there are shown preferred embodiments.

Referring to FIGS. 1-3 in a first embodiment, a beam actuator 1a comprises a pair of opposed support structures 2, 3, which may be attached to a larger substrate(s) (not shown). At least two individual beam segments 4, 5, which have their central axes offset from one another, are positioned between the opposed support structures 2, 3. The offset amount may be greater or less than the individual beam widths—if it is greater than the individual beam widths, a coupler 6 (also referred to herein as a yoke, coupling point, and coupling joint) is included between the two beams.

The operation of the actuator 1a is as follows: each of the beam segments 4, 5 is lengthened or shortened by some method known in the art, while the distance between the support structures 2, 3 is fixed. This generates a moment at the connection (i.e., at coupler 6) because of the offset beam axes, causing the connection points between the various beam segments 4, 5 to rotate. Removal of the force that causes the lengthening or shortening returns the beam segments 4, 5 to their original shapes.

While two conductive beam segments 4, 5 are shown in the drawings, those skilled in the art would understand that more than two beam segments in various combinations with one another and their respective support structures could be used in accordance with the embodiments herein. Increasing the number of beam segments would increase the force output of the actuator. It would also increase the rigidity and stability of the actuator, as a more rigid actuator would be less susceptible to the beam buckling failure. For more than two beam segments, the beam segments and structures would be offset towards opposing vertices and oriented at angles to one another coinciding with the external angles of various polygons (e.g., three beams segments would be oriented at 120°, four beams segments would be oriented at 90°, etc.). The number of beam segments would dictate the shape of the coupler 6. Those skilled in the art would also understand that the orientations would not be limited to equiangular or regular polygons, as variations in the beam angles would achieve greater directionality and moment control of the actuator. In these embodiments there is a central pivot location. Each actuator beam is positioned with its longitudinal axis offset from the central pivot point so as to generate a torque from the lengthening or shortening of the actuator beam. In one embodiment, a current passed from one support 2 to the other support 3 generates joule heating, which in turn causes thermal expansion of the beam segments 4, 5. The change in length generates a moment about the coupling location (i.e., at coupler 6) which causes the center of the actuator 1a to rotate. Because the beam segments 4, 5 are relatively slender, the actuator 1a bends with little structural resistance, taking a second-order mode shape as shown in FIG. 2.

Other possible configurations include using more than two beams to generate higher order mode shapes. For example, a device incorporating three segments 4, 5, 7, with the end segments 4, 5 aligned and the central segment 7 offset can be utilized, as depicted in the actuator 1b of FIG. 3A. If a rotational-translational coupler 6 is included at each of the joints, the result is a set of microgrippers or microtweezers as depicted in FIG. 3B. The microgrippers and microtweezers function using exactly the same electromechanical principals that have been previously described. As discussed, current passing from support 2 to support 3 generates Joule heating thus creating expansion or contraction and activation. In this embodiment actuation in the form of rotation about a point causes the jaws of the microgrippers or microtweezers to come together and converge. Other actuation techniques to cause the beams 4, 5, 7 to lengthen or shorten are possible as well, with thermal and piezoelectric actuation being just some example techniques.

Bidirectional actuation (both positive and negative rotations) can be achieved in different ways. Positive rotation here is taken to be clockwise motion of the connection point and the coupler 6, which results from lengthening or shortening of the beam segments 4, 5. For a thermal actuator, a bias current can be used to provide some initial positive rotation, and the current can be lowered from there to cool the beam segments 4, 5 and cause them to slightly contract and produce a negative rotation. Alternatively, the current can be raised above the bias to produce more positive rotation. For a piezoelectric beam, a positive voltage applied to the electrodes causes a contraction in beam length which results in negative rotation; a negative voltage applied to the electrodes causes an expansion in beam length, which results in a positive rotation. Beam contraction is advantageous over beam expansion, as beam segments 4, 5 under tension are less susceptible to beam buckling. If more than two beam segments 4, 5, 7 are included in the actuator 1a, both positive and negative rotations can be achieved at different connection points (i.e., at coupler 6) between the segments 4, 5, 7 as described above. Similarly, with regard to FIG. 3B, the microgripper embodiment of the present invention, positive voltage results in the gripper jaws moving toward each other. Removing power causes the jaws to revert to their open position which is their relaxed state position.

The inventors have contemplated the invention encompassing many versions of the microgrippers and microtweezers. Also contemplated are numerous sizes, shapes and configurations for grasping jaws and actuation means. These include but are not limited to normally open jaws, normally closed jaws, serrated jaws, parallel plane jaws, tapered jaws, and articulated jaws.

With actuator 1a, the displacements can be large, as in the hot-arm/cold-arm design, along with large force, as in the bent-beam design. However, power consumption is significantly lower than either of these other two types. The main advantage over the buckled beam actuator is a continuous range of deflection without any instabilities inherent in buckling designs. Other MEMS actuation mechanisms can be used in another embodiment of actuator 1a. Because the fundamental concept is a type of displacement amplification, the actuators best suited for the task are those that by themselves produce high force and low displacement. The extensional strain from a piezoelectric cantilever work very well in this configuration, and draws even less current and voltage than the thermally-driven type actuator.

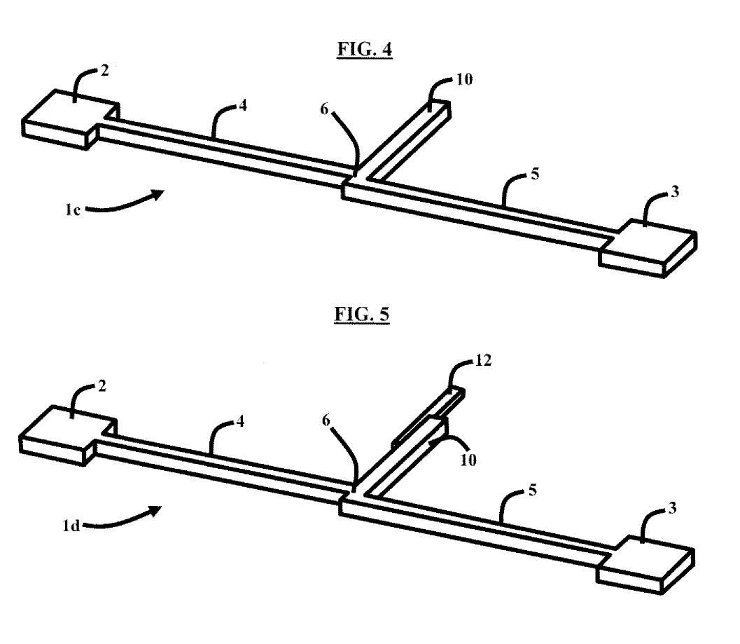

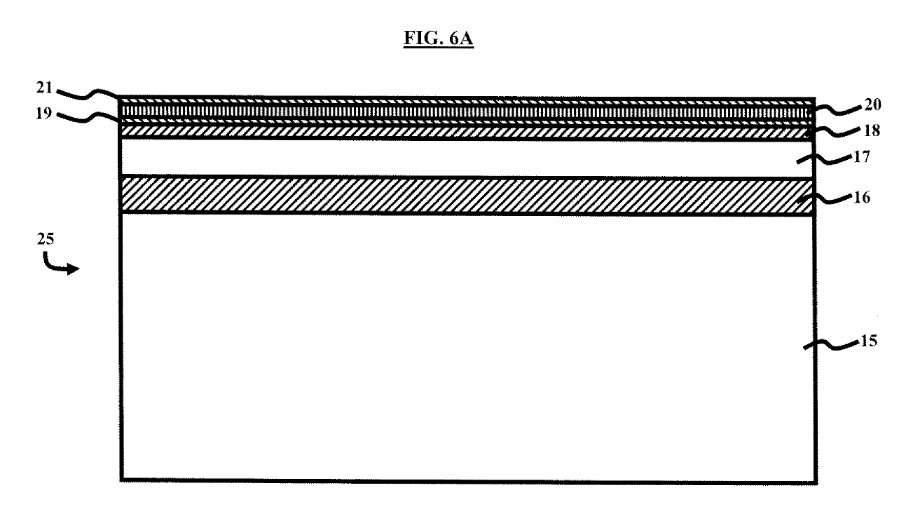

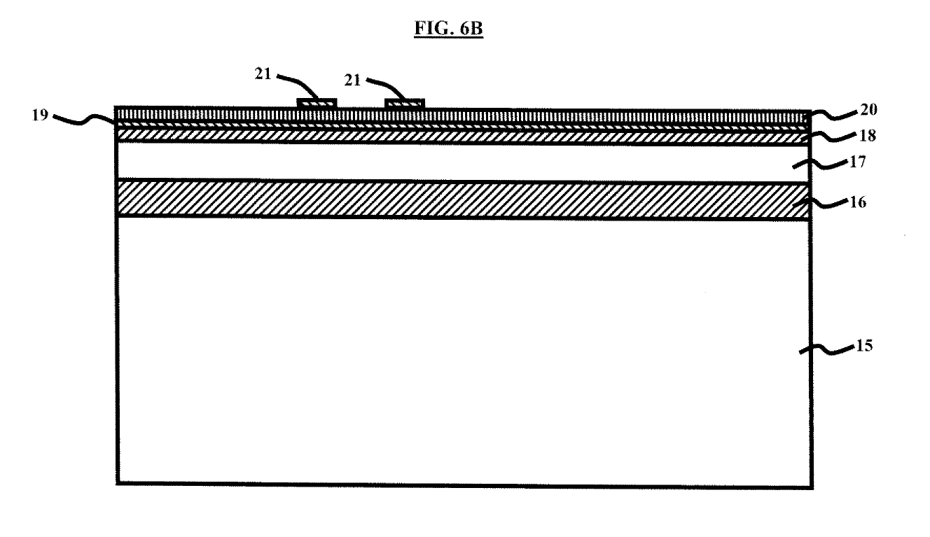

The embodiments herein further comprise an actuator 1c that also includes, at the coupling location (i.e., coupler 6) or at other locations along either beam 4, 5 one or more transverse members 10, as shown in FIG. 4, to convert rotational displacements to translational displacements. The actuator 1c is composed of two parallel, yet offset beams 4, 5 that are connected to a free perpendicular amplification beam 10. A released cantilever 12, as shown in the actuator 1d FIG. 5, may also be integrated with the beam 10 to serve as a resisting spring to the actuator movement.

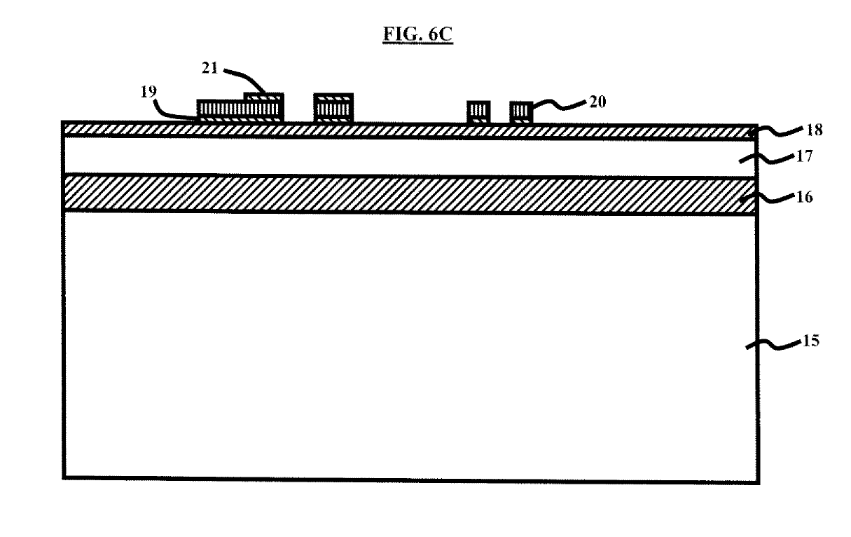

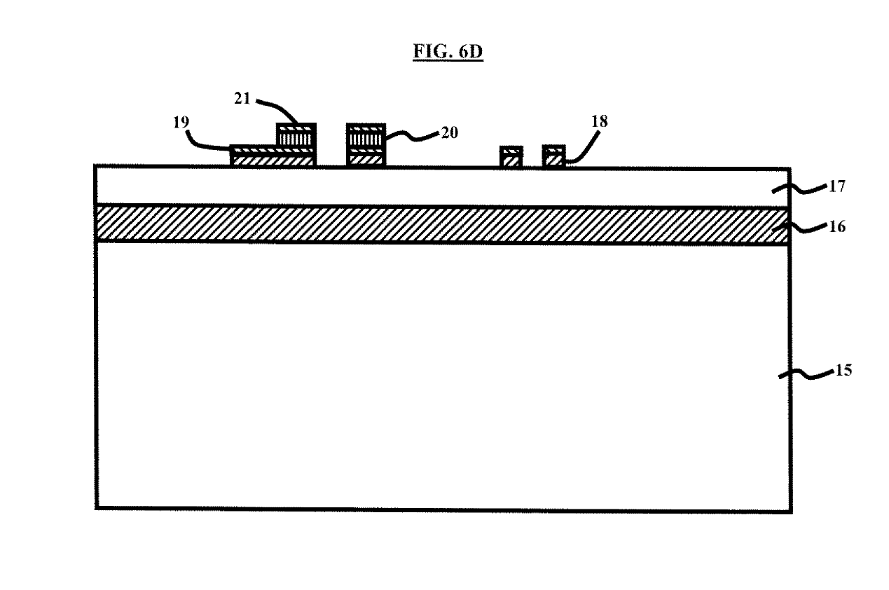

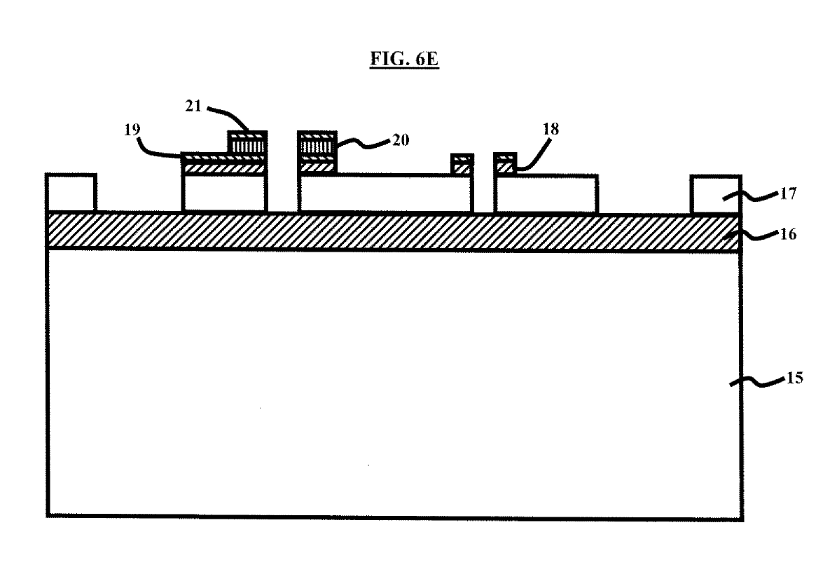

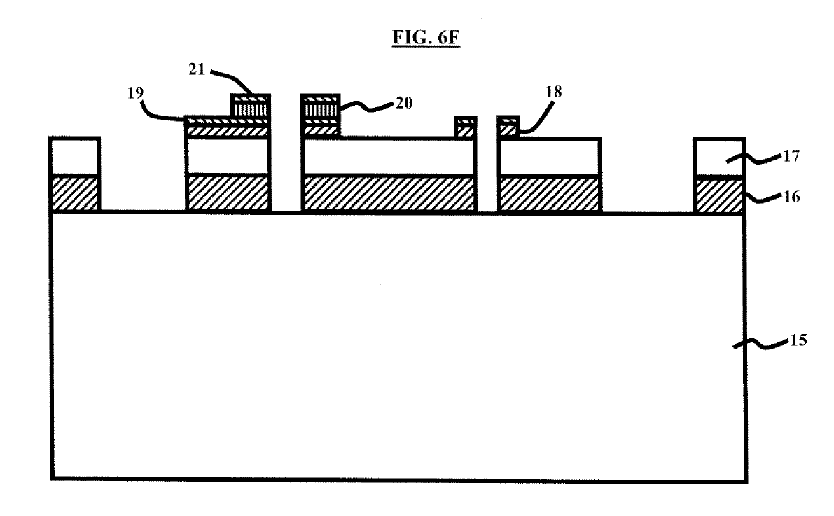

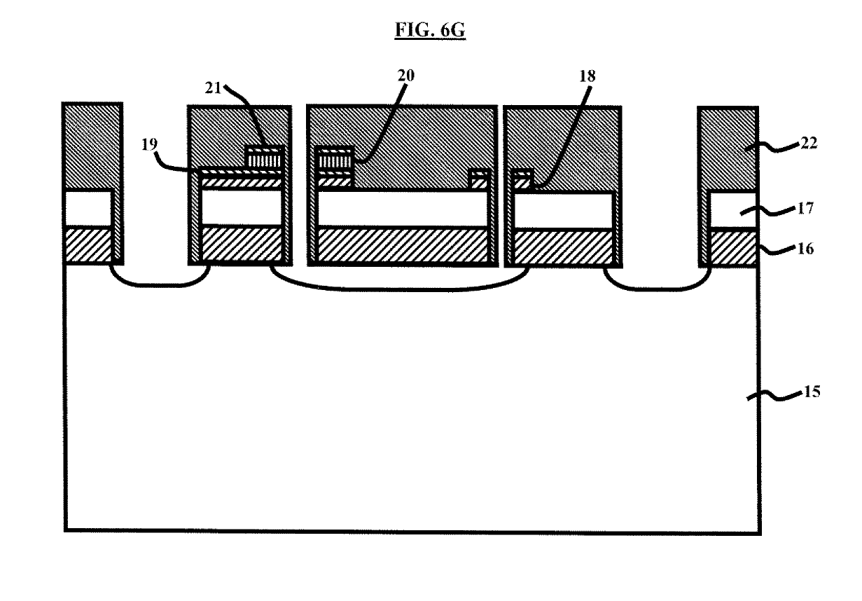

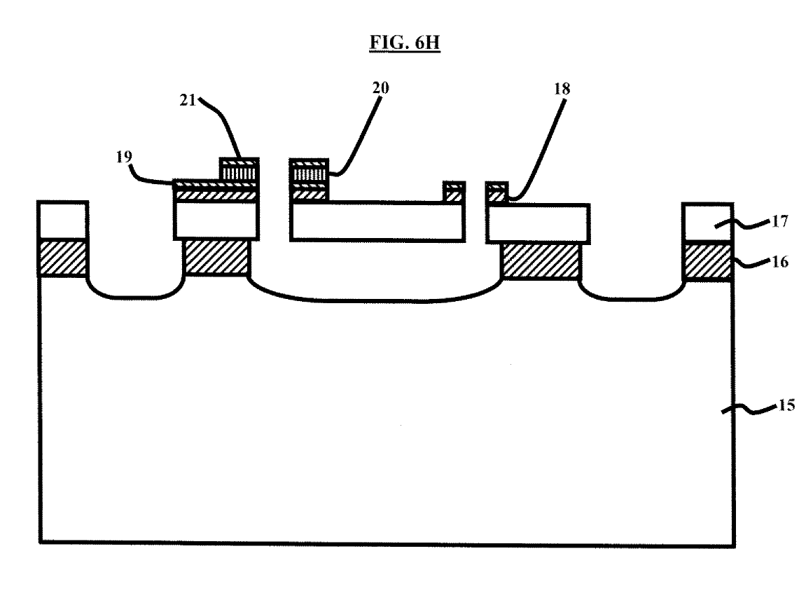

The two offset beams 4, 5 are the actuation beams where deformation occurs. As shown in FIGS. 6A through 6H, a piezoelectric stack 25 comprising of a PZT film 20 sandwiched between a top and bottom metal electrode 19, 21 serves as the transducer. When a bias is applied to the two electrodes 19, 21, the PZT polarizes and transforms along its transverse expansion (d₃₁) mode. Since the electric field is applied across the film thickness, the actuation beams 4, 5 compress axially and pull on the yoke (i.e., coupler 6) that connects the two beams 4, 5. This generates a torque around the central point of the yoke (i.e., coupler 6), which causes the amplification beam 10 to rotate. The angle of rotation is dependent on the stiffness of the two actuation beams 4, 5 and the magnitude of the torque.

In accordance with FIGS. 6A through 6H, the rotational actuator 1a-1d can be fabricated on a silicon-on-insulator (SOI) wafer comprising a 2 μm silicon device layer 17 over 1000 Å of buried silicon dioxide 16. The device silicon 17 is used as a structural support for the actuating piezoelectric layer 20, while the buried oxide 16 protects the base of the device silicon 17 from etching during the release of the actuator. The piezoelectric stack 25 is fabricated on top of the device layer 17. Initially, a thin layer of plasma enhanced chemical vapor deposition (PECVD) silicon dioxide 18 is deposited, followed by the sputtering of a seed layer of titanium and then platinum for the bottom electrode metal 19. The piezoelectric layer 20 is deposited with sol-gel PZT on the wafer. Metallization for the top electrode 21 is performed by sputtering platinum onto the wafer as illustrated in FIG. 6A.

The top electrode 21 is formed by patterning and ion milling the top metal layer 21 as shown in FIG. 6B. The PZT 20 and bottom metal 19 are subsequently ion milled with a separate mask to shape the actuator as shown in FIG. 6C. A PZT wet etch (e.g., DI water, HCl acid, and HF acid) is used to expose the bottom metal 19 for electrical contact as illustrated in FIG. 6D. In areas where the metals 19, 21 and PZT 20 are removed, the underlying PECVD-deposited oxide 18 is etched away by a reactive ion etch to expose the device silicon 17. The device silicon layer 17 is patterned by deep reactive ion etching (DRIE) to delineate the beams and contact pads as shown in FIG. 6E. The exposed buried oxide 16 is removed by reactive ion etching (RIE) to allow for etching and undercutting of the silicon handle wafer 15 as shown in FIG. 6F. The etch is briefly continued into the handle wafer 15 by DRIE. A thick photoresist 22 is spun on the wafer to fill the trenches around the devices and is patterned to protect the sidewalls of the devices. The silicon handle wafer 15 is etched with XeF₂, undercutting the beams and releasing the device as illustrated in FIG. 6G. Lastly, a buffered hydrofluoric (BHF) oxide etch is performed to remove the buried oxide 16 from the bottom of the beams. The wafer is ashed in oxygen plasma to remove any remaining residues and particulates as shown in FIG. 6H.

Experiments on the configurations were performed and test data was recorded for devices with an actuation beam length of 500 μm and a thickness of the 2 μm device silicon layer 17 and an additional PZT thickness of 1 μm. The resisting springs 12 were patterned only in the device silicon 17 to be 500 μm long and 2 μm thick. The dimensions of the actuation beams 4, 5 were 485 μm long (from the center of the yoke 6 to the tip), 25 μm-wide, and 2μm thick. Various actuator beam and resisting spring widths were tested to determine deflection trends, generated forces, and the stiffness of the actuators 1a-1d. The actuator beam widths tested were 5, 7, and 10 μm, while the resisting spring widths for force testing were 10, 15, and 20 μm. Devices without resisting springs 12 were also included to test free deflections. Measurements of the deflections were taken from a Vernier scale.

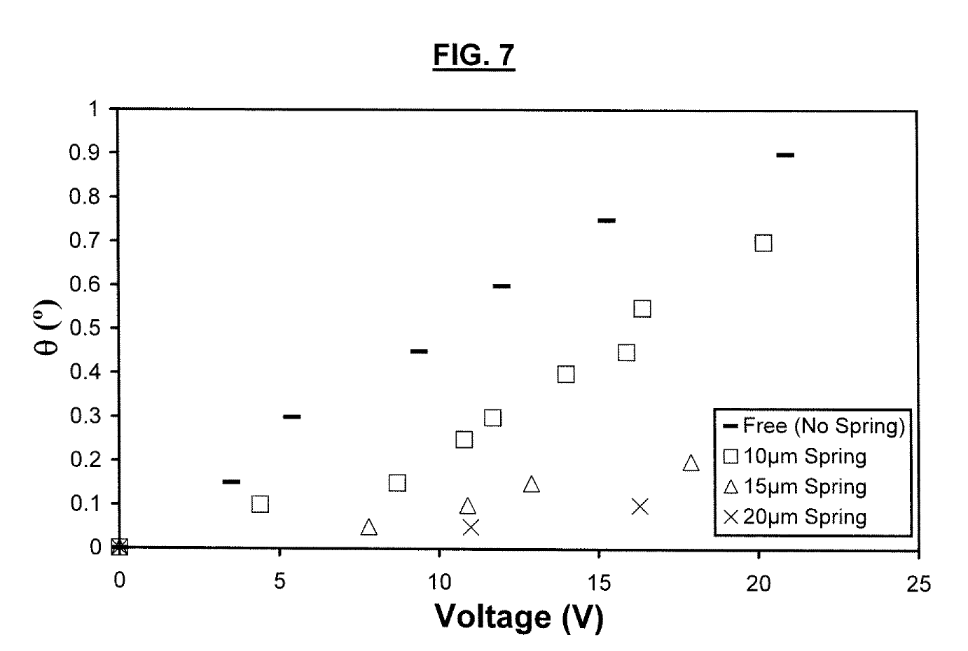

Devices are tested by varying the applied voltage until a pair of Vernier marks aligned. The deflection angle gradations of the angular Vernier scale are 0.15°; therefore, the error associated with this on-chip measurement is estimated as ±0.075°. To determine the change in deflection, the measured angle is subtracted by the initial angle of deflection under no bias, θ₀, which is inherent from intrinsic stresses. FIG. 7 illustrates deflection graphs for four 5 μm-wide actuators with various resisting spring widths, including one with no resisting spring 12. The data confirms the expected operation of the actuators, as larger deflections occur for thinner springs 12 under the same bias. Thinner springs 12 have a smaller spring constant, which represents a smaller opposing force against the deflecting actuator beams 4, 5. Approximate translational displacements can be determined by trigonometry, given the angle of deflection and the length of the amplification beam 10.

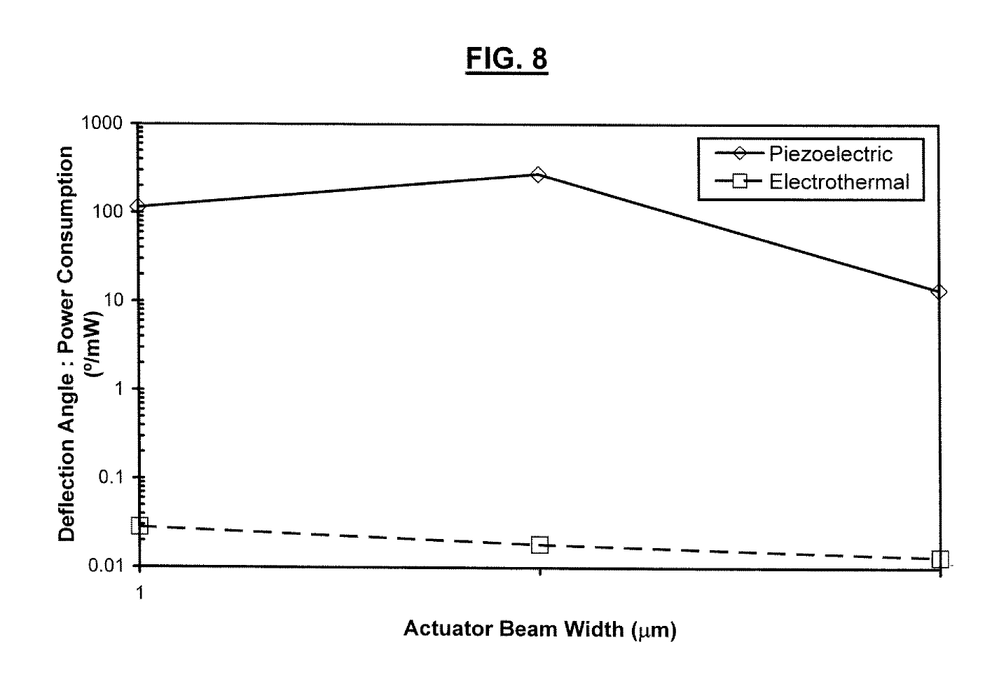

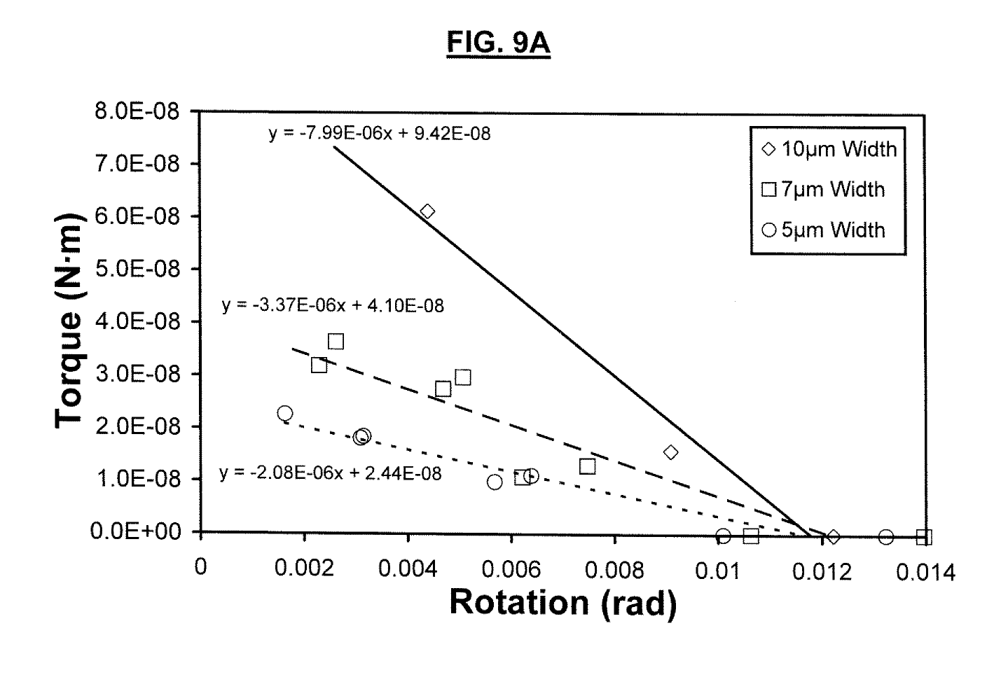

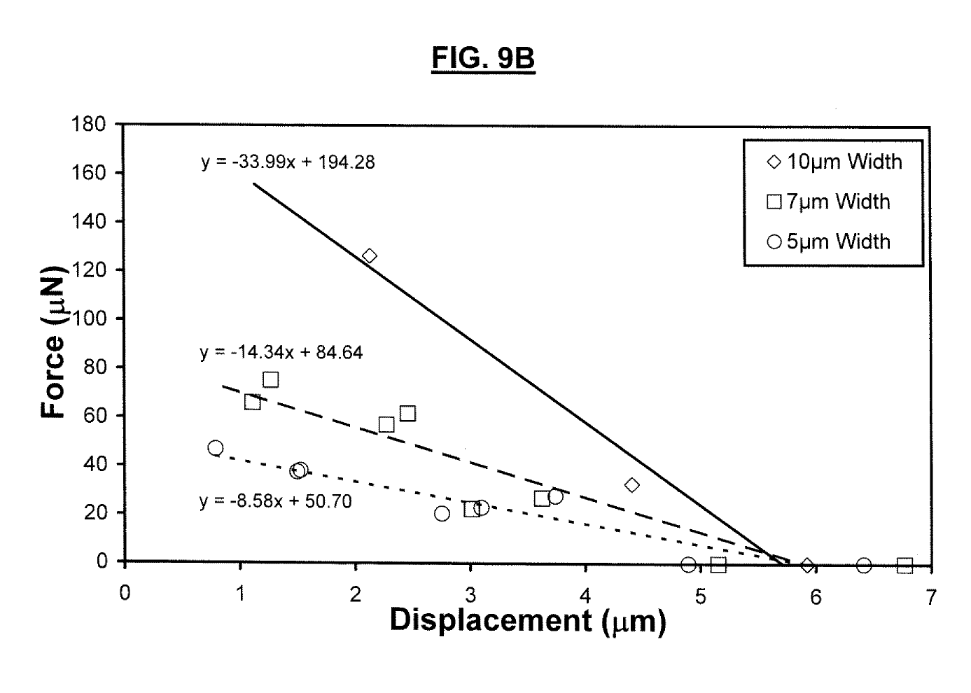

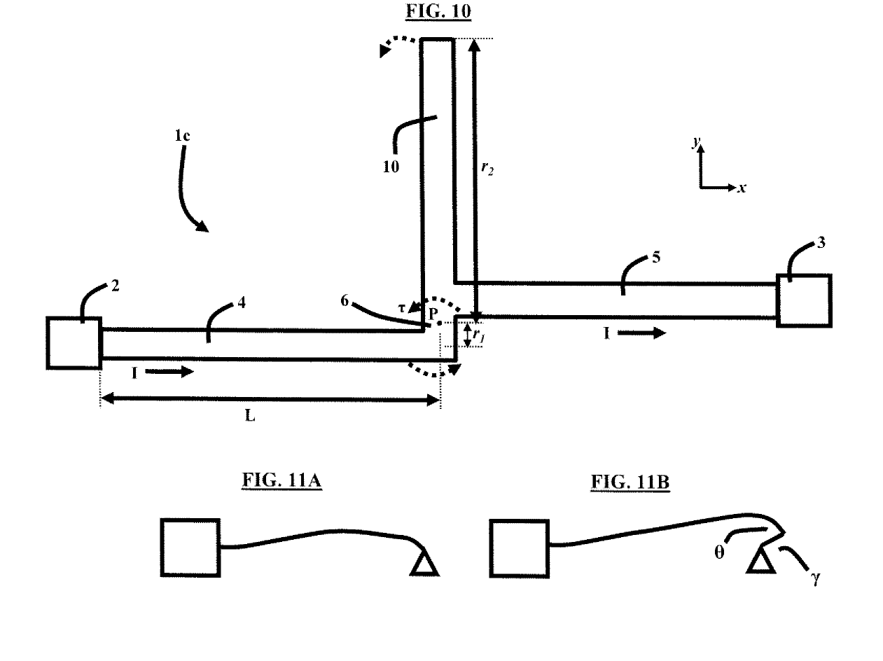

The effectiveness (deflection per unit power) for the maximum free deflection of the piezoelectric versus electrothermal actuators is shown in FIG. 8. As electrothermal actuators are characterized for their ability to generate large forces (v-beam designs) or large displacements (u-beam designs), they serve as a good standard for comparison. Although limited to smaller deflection angles and forces, the piezoelectric actuators require orders of magnitude of less power per angle of deflection due to a much smaller current draw. To normalize the data from various voltages, the values can be extrapolated from nearest neighbors to determine deflections at a common voltage. Assembling all of the data for varying spring stiffnesses and actuators, a torque-rotation graph is constructed for various actuator widths, which is displayed in FIG. 9A. As torque and rotation are analogous to force and displacement, a corresponding force-displacement graph is also shown in FIG. 9B. The area under a curve is the feasible region for the actuator output, with the maximum force equal to the y-intercept and the maximum displacement equal to the x-intercept. Given a required force, the maximum displacement can be read from the curve, and the same is true for a given required force. In addition, by comparing the measured force-displacement relationship for a given set of actuators of the same dimensions at the common bias, the slope of a line represents the stiffness of the actuator 1a-1d. The generated actuator spring constants are credible, as wider actuators contain a larger volume, which have a greater stiffness. The validity of the embodiments herein can also be demonstrated through mathematical formulations as further described below.

Looking at a top view of the actuator 1c (of FIG. 4), again the rotational actuator 1c is shown comprising of three beams 4, 5, 10 connected at a common yoke 6, as shown in FIG. 10. The two actuating beams 4, 5 are parallel yet offset to each other and are fixed at opposite ends to structural supports 2, 3, while the third beam 10 is free to deflect. In a thermal configuration, when a current is applied to the thermal actuator 1c, the actuator beams 4, 5 heat up, causing the material to expand. Due to the offset between the two actuating beams 4, 5, the axial expansion creates a torque τ around point P on the yoke 6. The torque causes the yoke 6 to rotate the third beam 10, where the angle of deflection is dependent on the stiffness of the two actuating beams 4, 5 and the magnitude of the torque. Furthermore, the linear deflection of the yoke 6 is dependent on the rotation angle and the yoke length. The spring constant, k, of the actuator 1c can be modeled as a modified clamped-clamped beam with a moment applied at the center. Assuming that the yoke 6 remains rigid, the clamped-clamped beam can be simplified into two clamped-pinned beams, which acts as two springs in parallel. Under actuation, the individual clamped-pinned beam behavior, illustrated in FIG. 11A, is modified as the thermal expansion causes the beam 4, 5 to extend around the pinned point with considerations to the length of the yoke 6, as shown in FIG. 11B. To address this issue, the clamped-pinned beam with overextension is treated as a standard clamped-pinned beam affixed to a stretching bar.

The torsional spring constant for the rotational actuator is the spring constants of two clamped-pinned beams 4, 5 and two stretching bars all in parallel,

$$k = \frac{8 EI}{{L}_{beam}} + \frac{2 EA {r}^{2}}{{L}_{beam}} , \qquad ( 1 )$$

where E is the Young's modulus, I is the moment of inertia, L_{beam} is the length of one actuator beam, A is the cross-sectional area of the bar, and r is the distance from the axis of the actuator beam to point P.

A curved Vernier scale may be placed at the end of the deflecting beam 4, 5 to measure the amount of rotation. The rotation angle can be related to the spring constant through a series of conversions that translates the angle of rotation into a force. First, the measured degree of rotation is converted into a linear displacement. The resisting force is extrapolated with the use of the displacement and an opposing beam/spring 12 (of FIG. 5), or latch, with a known spring constant through Hooke's Law, F=−kx, as shown below,

F=−k_{latch}*L_{yoke}*sin(θ_{d}), (2)

where k_{latch} is the known spring constant of the latch, L_{yoke} is the length of the central yoke 6, and θ_{d} is the measured angle of deflection. The spring constant of the latch is found from the equation for a cantilever beam with a transverse load applied at the tip,

$${k}_{latch} = \frac{3 EI}{{L}_{latch}^{3}} , \qquad ( 3 )$$

where L_{latch} is the length of the spring/latch 12. By determining the linear relationship between the actuator output force and the displacement with a given input current, the linear and torsional spring constant of the actuator 1c, 1d can be determined by applying Hooke's law.

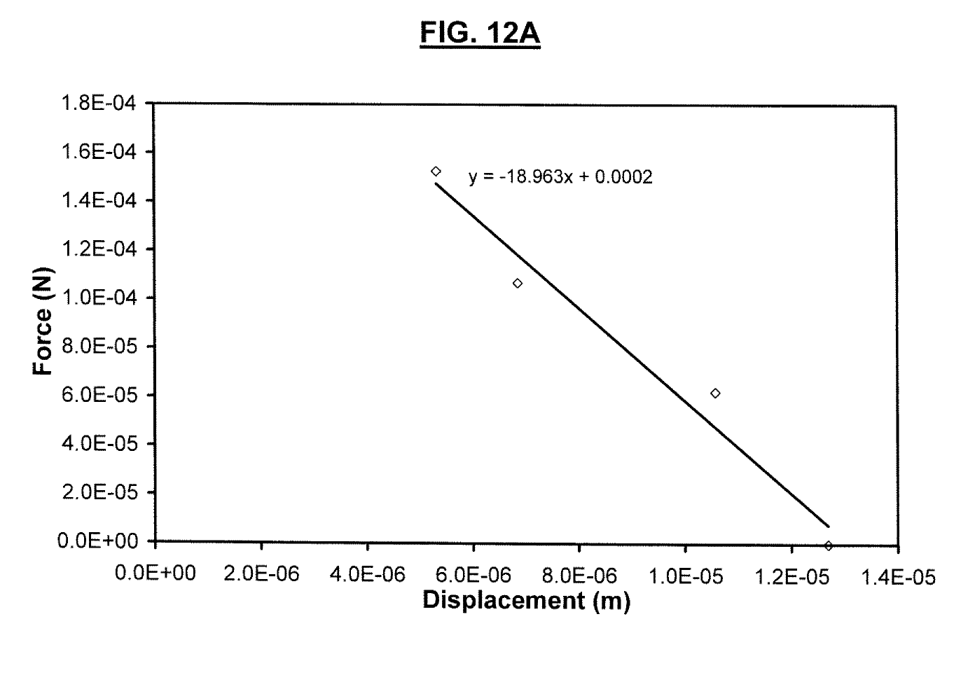

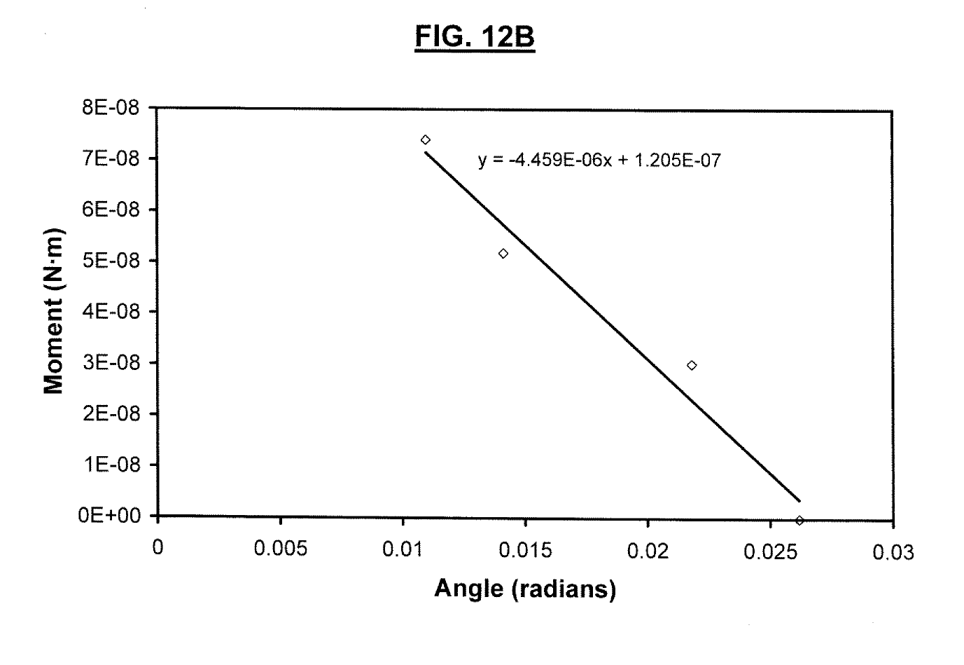

The actuator 1c exhibits output forces that are strongly dependent on the width of the actuating beams 4, 5. Beams with the width of 5 μm tend not to be able to exert sufficient force to deflect the wider latches through the scope of the Vernier from 0-1.5°. The activation current is also strongly dependent on the beam width, as wider actuator beams require greater currents to achieve the same deflection. Furthermore, actuating beams with larger lengths require less current to generate displacements similar to the shorter beams. A maximum lateral displacement of 23.7 μm with 0.17 mN of force has been experimentally measured, and a maximum force of 0.97 mN with a deflection of 17.7 μm has been experimentally measured. As previously mentioned, the measured angular displacement is translated into generated force. From these values, the spring constant of an actuator 1c is determined by extracting the forces and displacements over different resisting cantilever latch widths for the same beam length, beam width, and current. The linear spring constant for a 7 μm-wide, 500 μm-long actuating beam 4, 5 is determined to be 18.96N/m, as shown in FIG. 12A. The respective torsional spring constant of 4.458 μN·m is shown in FIG. 12B. The resulting spring constants and their theoretical values for the actuators 1a-1d are shown in Table 1.

TABLE 1
Actuator data

| | | | Measured | Measured | Theoretical | |
|---|---|---|---|---|---|---|
| | | | Linear | Torsional | Torsional | |
| Beam | Beam | Cur- | Spring | Spring | Spring | |
| Length | Width | rent | Constant | Constant | Constant | Percent |
| (μm) | (μm) | (mA) | (N/m) | (μN · m) | (μN · m) | Error |
| 400 | 5 | 7.7 | 7.93 | 3.04 | 2.82 | 7.6 |
| | 7 | 11.5 | 15.80 | 4.94 | 4.89 | 1.0 |
| | 10 | 16.6 | 24.34 | 7.33 | 9.86 | −25.6 |
| 500 | 5 | 8.9 | 10.34 | 2.43 | 2.25 | 8.0 |
| | 7 | 12.9 | 18.96 | 4.46 | 3.91 | 14.0 |
| | 10 | 14.6 | 42.68 | 10.04 | 7.89 | 27.2 |
| 600 | 5 | 10.4 | 12.91 | 1.86 | 1.88 | −0.9 |
| | 7 | 15.2 | 21.01 | 3.72 | 3.26 | 14.0 |
| | 10 | 22.9 | 31.19 | 5.72 | 6.57 | −12.9 |

The measured torsional spring constants hold some consistency with expected theoretical values. The predicted values for the 5 μm-wide beams are accurate within 8% error while greater inaccuracies occur for the 7 μm-wide beams. The measured spring constants for the 10 μm-wide beams are marginal with about 25% error to theory. The resolution of the Vernier scales has little effect on the result, as a ±0.1 error in alignment with the gradations only changes the measured spring constant by 0.01 μN·m.

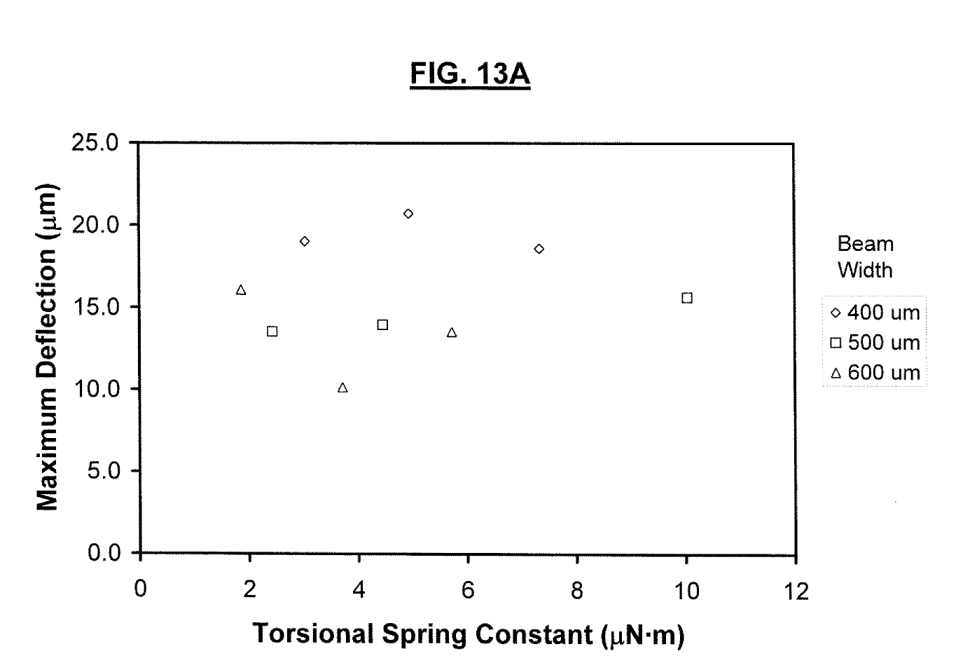

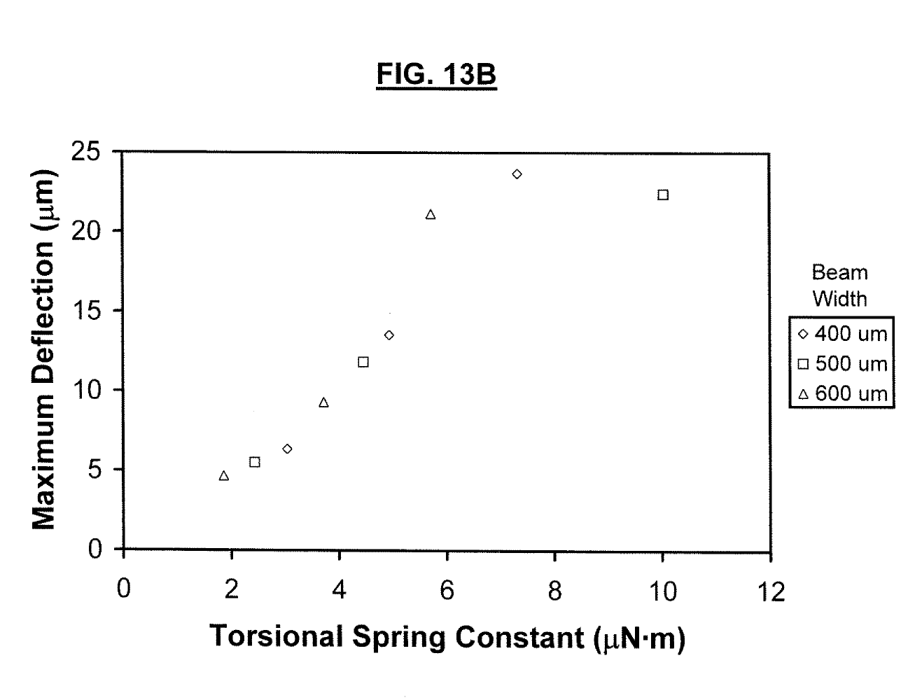

The maximum deflections for two actuator types, one with a 20 μm-wide latch 12 (actuator 1d) and one that is free (no latch) (actuator 1c), are compared to their torsional spring constants in FIGS. 13A and 13B. The actuators 1c-1d are driven to their maximum currents before device failure (buckling or irreversible plastic beam deformation), and the maximum deflections are measured. The measured and theoretical spring constant decreases with longer beams 4, 5. The free actuator data shows inconsistency with the expectation that the smaller latch spring constants will result in larger deflections. Comparatively, the spring constant is relatively proportional to the maximum displacement for the actuators with the 20 μm-wide resisting cantilever, with the exception of the 500 μm-long, 10 μm-wide beam.

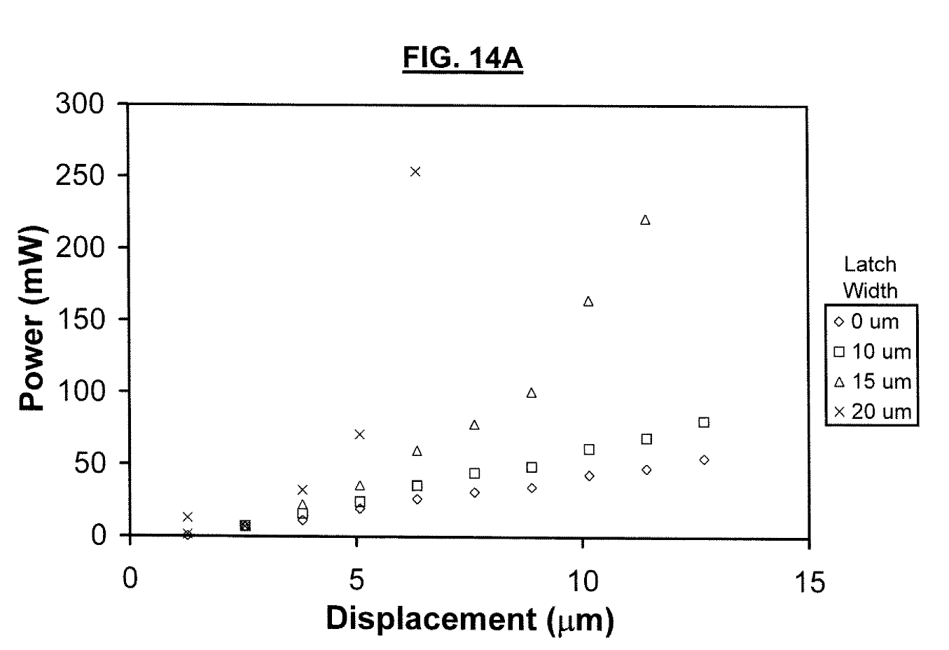

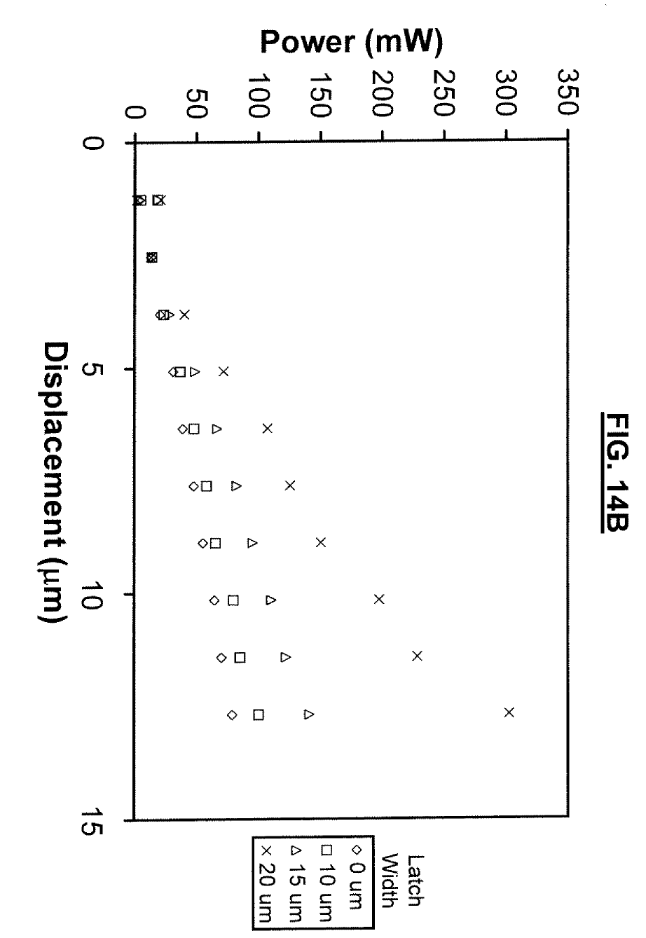

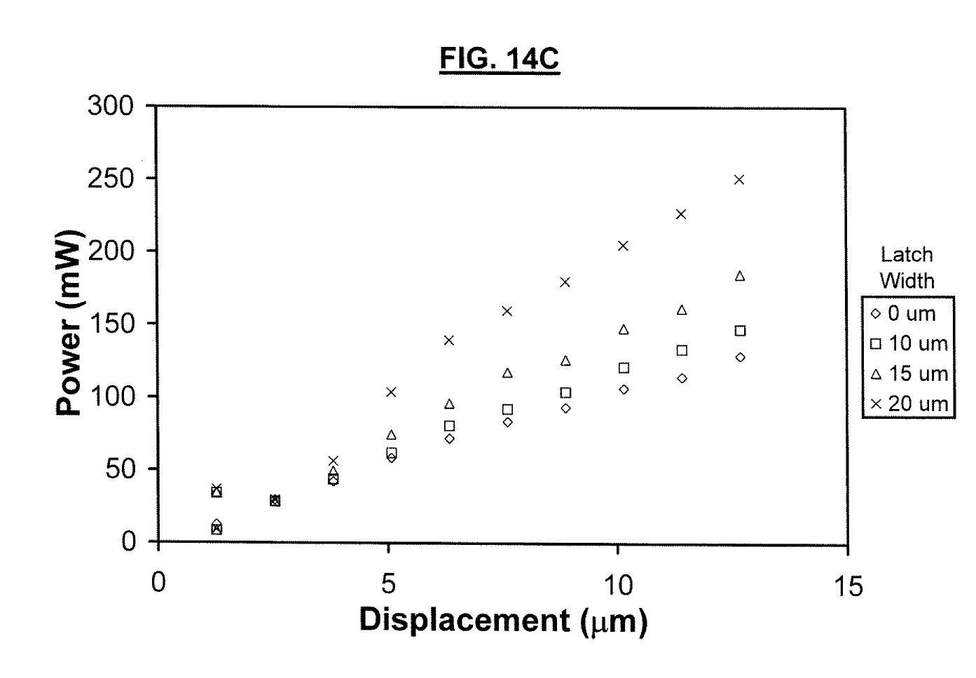

By observing the current and voltage required to generate the deflections, the power consumption of the actuators 1c-1d can be calculated. The power consumption by displacement for the 400 μm-long beams is shown in FIGS. 14A through 14C. For the free and 5 μm-wide latch devices, the required power appears to be directly proportional to the displacement. The linearity holds for the actuators with 10 μm-wide beams for all latches; however, the power consumption shows an exponential relationship for the thinner actuating beams with wider latches. This corresponds to the inability of the thinner actuators to generate sufficient force to push stiffer springs through larger deflections.

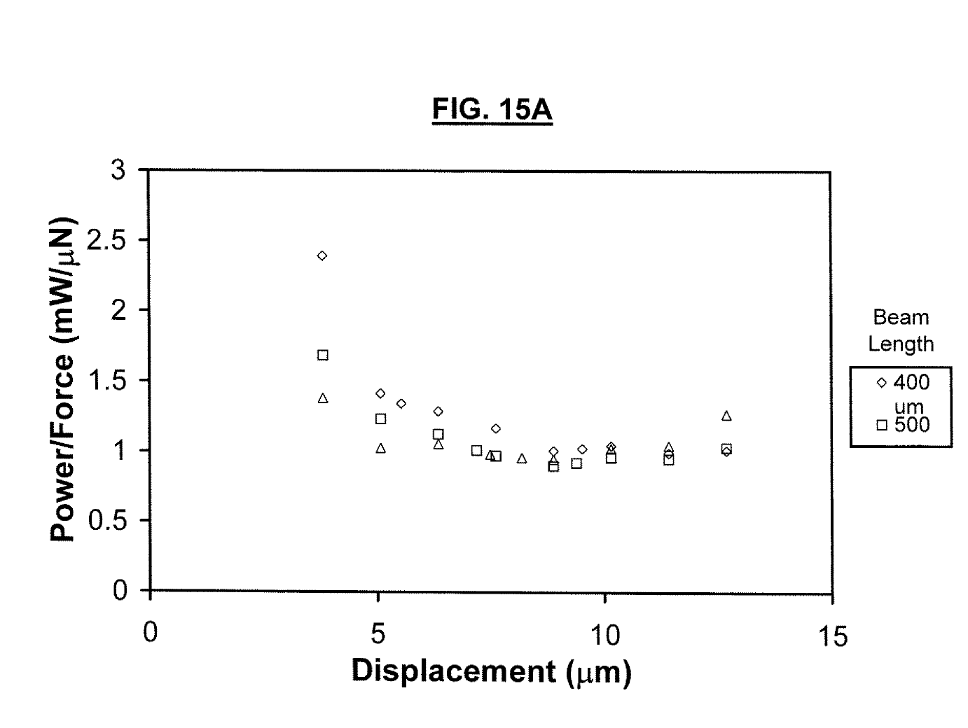

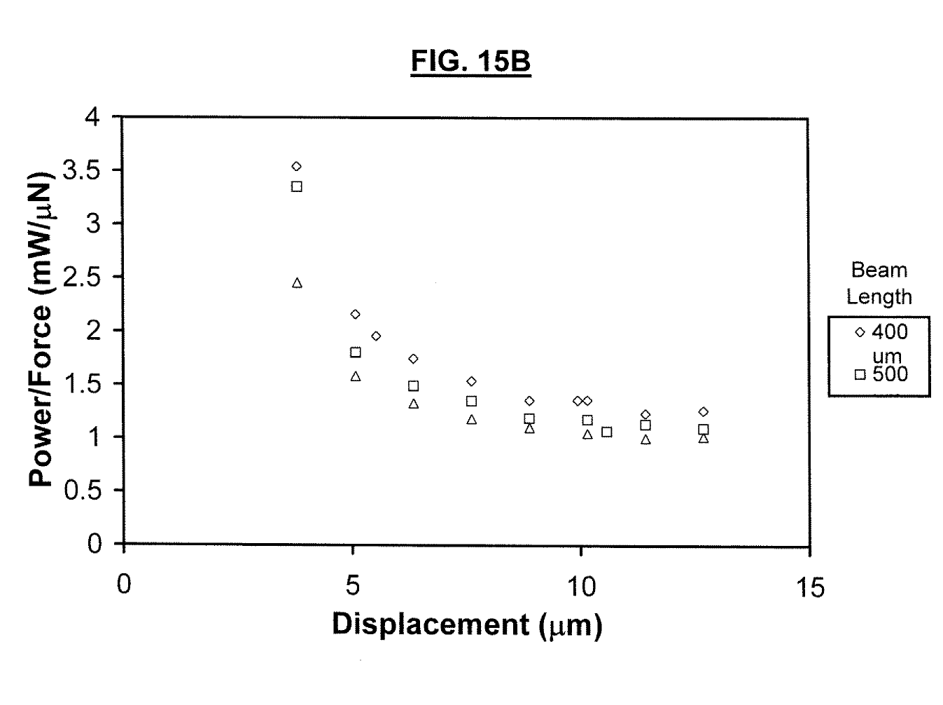

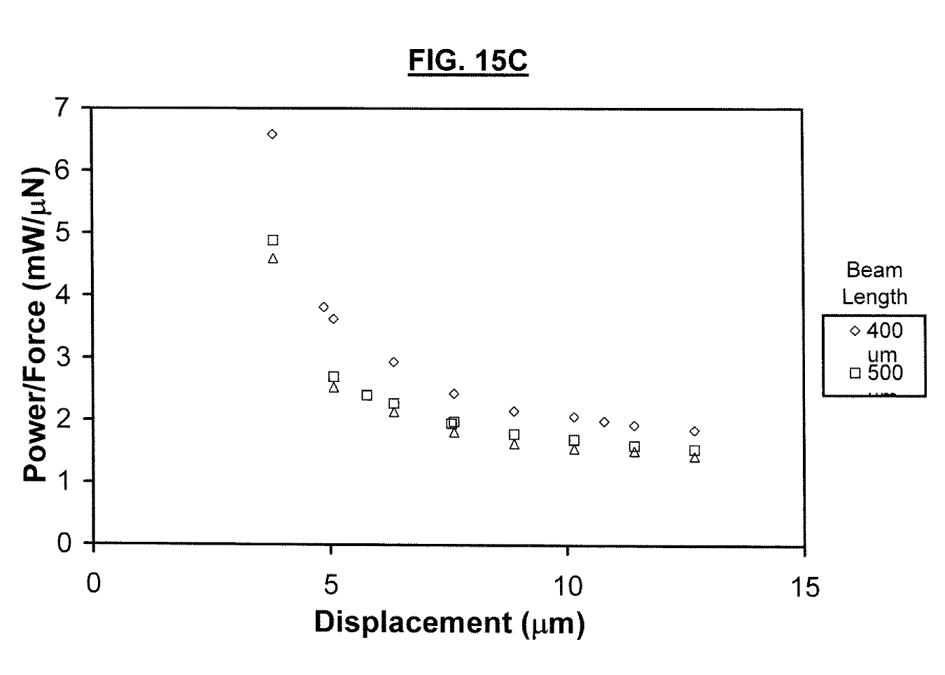

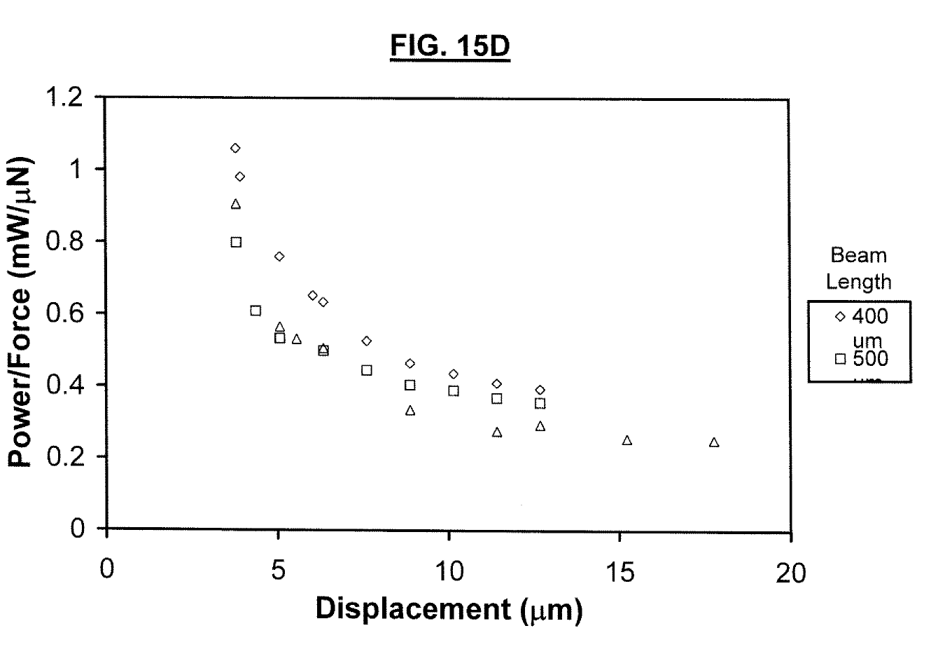

A metric for the efficiency of the actuators 1c-1d is created by comparing the power consumption with the force generated. The results plotted against the actuation displacement are shown in FIGS. 15A through 15D. The power consumption per unit force is plotted on the y-axis; therefore, the lower values are more efficient. As the short, wide beams require more current, they have a lower efficiency in comparison to the longer and narrower beams. Furthermore, as devices with wider latches are able to generate larger forces, they exhibit greater efficiencies with less than 0.5 mW/μN of power consumption.

The power consumption per unit force tends to approach a minimum as expected, which corresponds to the maximum deflection. For a 5 μm-wide beam, the efficiency decreases after 10 μm, indicating that the actuators have reached their peak performance, as the beam bending becomes nonlinear and the actuator stiffness decreases. From this point, they cannot continue to generate the force required to deflect the spring/latch 12 further. For the wider actuator beams, the efficiencies approach a limit, as the minima are not realized.

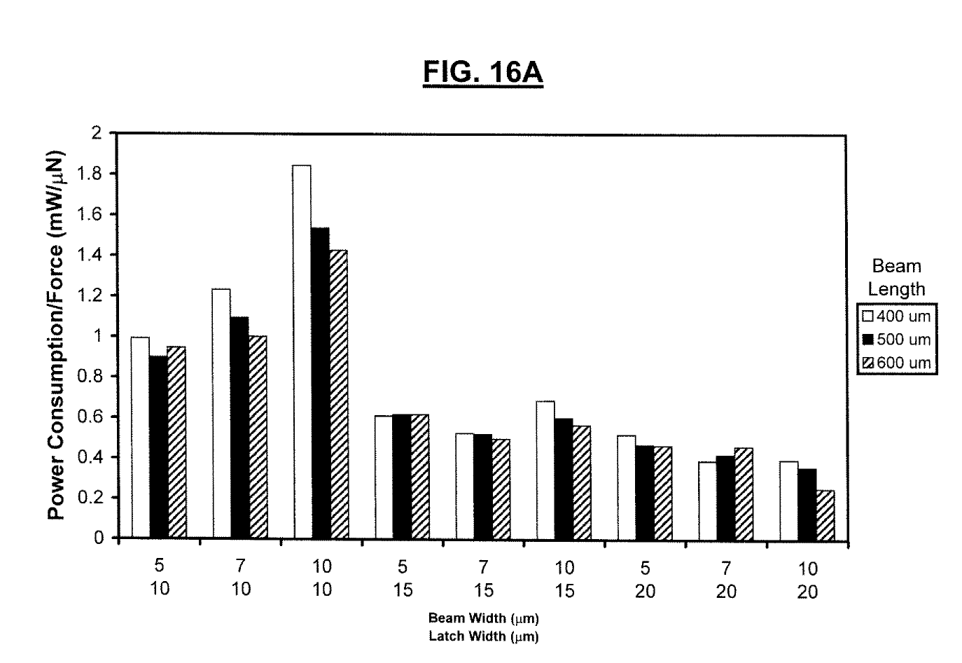

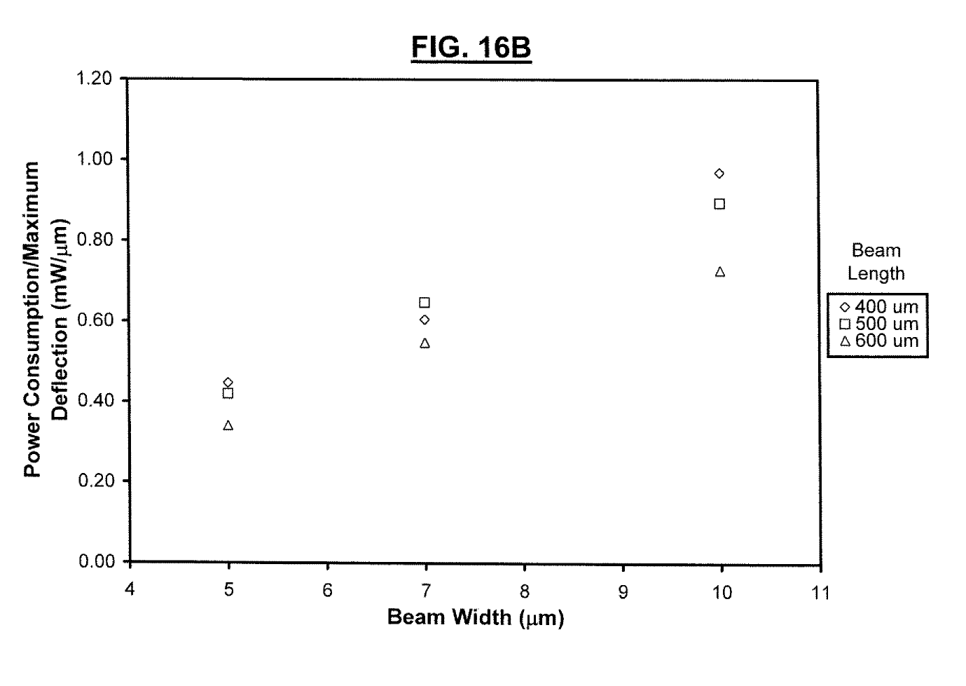

The peak force efficiencies for various actuator beam dimensions are plotted in FIG. 16A. The best performing actuators are the ones with the widest latches since a relatively larger portion of the generated force is used at the output. Furthermore, the longer actuator beams tend to be more efficient than the shorter beams for constant beam and latch widths. The comparisons of power consumption per unit force for varying beam widths confirm the trends for matching the force output design with its appropriate application. Ideally, spring constants of beams that match the spring constants of latches perform better. As the thinner latches require smaller forces for deflection, the thinner actuator beams are more appropriate and perform more efficiently than the wider beams. Alternatively, wider latches require a greater force such that the wider actuator beams are more efficient. This holds for the medium 15 μm-wide latch, where the medium 7 μm-wide beam is more efficient than the other two beam widths. The 5 μm-wide, 500 μm-long beam with a 15 μm-wide latch illustrates an efficiency inversion point for the actuators where the power consumption per unit force appeared the same for all lengths.

FIG. 16B shows the power consumption per unit of maximum displacement for free actuators 1c. Although the 400 μm-long beams exhibit greater peak deflections, the shorter free actuators generally have higher power consumptions per unit deflection. Therefore, the longer actuator beams, which are more efficient with respect to peak forces, are more efficient for maximum deflections as well. Furthermore, the thinner beams consume less power for maximum deflection, which further supports the previous proposition that the beam efficiency strongly relates to matching the beam spring constant with the latch spring constant, even for an infinitely small latch spring constant. This is consistent with the maximum power theorem, as the optimal power transfer occurs with matched impedances.

The rotational offset-beam actuators 1a-1d overcomes the low force limitation of typical u-beam actuators while reducing the required power compared to typical v-beam actuators. The offset beam actuator 1a-1d therefore provides for free displacement approaching similarly sized u-beam actuators, maximum output force approaching similarly sized bent-beam actuators, with power consumption on the order of u-beam actuators. Output forces of up to 1.44 mN simultaneous to displacements greater than 20 μm are achievable, indicating that these actuators 1a-1d provide better force-displacement performance than typical hot arm/cold arm style actuators. Similar free deflections are obtained from the offset-beam actuators 1a-1d with about 40% less current and voltage (i.e., 64% less power) compared with typical linear bent beam actuators.

Again, the experimental devices include actuators with beam length L (referring to FIG. 10) of 400 μm, 500 μm, and 600 μm, and beam width w of 5 μm, 7 μm and 10 μm. In all the devices the actuator moment arm r₁ is 5 μm. An angular Vernier scale is included on each device to measure angular deflection. Equivalent linear deflection in the x-direction is calculated from the angular deflection measurement as

$$x = - 2 {r}_{2} sin \frac{θ}{2} . \qquad ( 4 )$$

To measure force, actuators of each beam width and beam length are made with adjacent resisting cantilever springs 12 (of FIG. 5) of widths 0 μm (no spring), 10 μm, 15 μm, and 20 μm. The initial gap between the spring and the actuator is 3 μm, which is subtracted from the total deflection for the force and moment calculations. Force output is calculated using the linear deflection of the spring and the cantilever spring stiffness calculated assuming small deflections. Moment output is derived by multiplying the force output by the moment arm r₂ taken from point P to the end of the amplifier beam 10.

Following the electro-thermal-mechanical modeling approach to model V-beam thermal actuators, the one dimensional steady state heat equation for a beam suspended over a substrate is:

$${k}_{s} \frac{{d}^{2} T ( x )}{d {x}^{2}} + {J}^{2} ρ - {Sk}_{a} \frac{T ( x ) - {T}_{∞}}{gh} = 0 , \qquad ( 5 )$$

where the parameters are as defined in Table 2.

TABLE 2
Parameter Definition and values used in model

| Parameter | Description | Value | |
|---|---|---|---|
| α | thermal expansion coefficient of silicon | | |
| ρ | electrical resistivity of silicon | 0.0058 | Ω-cm |
| g | air gap between beam and substrate | 2 | μm |
| h | height of beam | 20 | μm |
| J | current density in beam | varies | |
| kₐ | thermal conductivity of air | 0.026 | W/m-K |
| kₛ | thermal conductivity of silicon | 148 | W/m-K |
| L | length of actuator | varies | |
| S | thermal shape factor | varies | |
| T_{∞} | ambient temperature | 298 | K |

| | | |
|---|---|---|
| w | width of beam | varies |

This model assumes that there is no temperature variation through the beam cross-section, and that the effects of convection and radiation are negligible compared to conduction. It is further assumed that the anchors remain at the substrate temperature T_{∞}. The first term in Equation (5) represents the heat loss through the ends of the beam; the second term is the heat generation in the beam, and the third term is the conductive heat loss through the air into the substrate 15.

The effect of heat loss through the sides of the beam is captured in the shape factor S. The resulting generalized shape factor is:

$$S = \frac{4}{w} ( g + \frac{h}{50} ) + 1. \qquad ( 6 )$$

This expression has a good fit to the finite element simulations for height to gap ratios of 10 to 40, with errors of less than 5% in this domain. Solving the differential equation (5) gives the temperature distribution along the length of the beam. The closed form solution is:

$$T ( x ) = {T}_{∞} + \frac{{J}^{2} ρ}{{k}_{s} {m}^{2}} [ 1 - \frac{cosh ( mL - mx )}{cosh ( mL )} ] . \qquad ( 7 )$$

where m is defined as:

$${m}^{2} = \frac{{Sk}_{a}}{{k}_{s} gh} . \qquad ( 8 )$$

The thermal expansion in the beam can be calculated from the temperature distribution by integrating the temperature rise over the length of the beam and multiplying by the coefficient of thermal expansion:

$$δ = α {\int }_{0}^{L} [ T ( x ) - T ( ∞ ) ] d x = \frac{α {J}^{2} ρ L}{{k}_{s} {m}^{2}} [ 1 - \frac{tanh ( m L )}{m L} ] . \qquad ( 9 )$$

With the thermal expansion of each beam known, one can calculate the moment exerted on the central beam by the two actuators:

$$M = 2 {r}_{1} \frac{δ EA}{L} . \qquad ( 10 )$$

To determine the resultant deflection, the actuator 1c-1d is modeled as two clamped-pinned beams with a moment applied at the tip of beam 10. An additional spring constant is used to account for the extension in each beam 4, 5 caused by the vertical offset between the two beams 4, 5. First, the torsional spring constant in a clamped-pinned beam is written as:

$${k}_{cp} = \frac{4 EI}{L} . \qquad ( 11 )$$

The torsional spring constant due to extension in each of the two beam segments is:

$${k}_{ext} = \frac{EA}{L} {r}_{1}^{2} . \qquad ( 12 )$$

The actuator spring constant is obtained by placing these springs in parallel to obtain the spring constant of each beam 4, 5, then placing the two beams 4, 5 in parallel to form the actuator.

$${k}_{θ} = 2 {k}_{cp} + 2 {k}_{ext} = \frac{2 E}{L} ( 4 I + {Ar}_{1}^{2} ) \qquad ( 13 )$$

The actuator free rotation angle is then calculated using Equations (10) and (13):

$$θ = \frac{M}{{k}_{θ}} = \frac{{r}_{1} δ A}{( 4 I + {Ar}_{1}^{2} )} . \qquad ( 14 )$$

For configuration purposes, it is useful to calculate the output moment and deflection limits of the actuator 1c-1d. Expected failure modes are buckling and fracture. The limits to the blocked moment and free deflection imposed by buckling are derived from the equation for the critical buckling force of a clamped-clamped beam with length 2 L:

$$\begin{matrix}{M}_{buck} = 2 {F}_{cr} {r}_{1} = \frac{2 {r}_{1} {π}^{2} EI}{{L}^{2}} & ( 15 ) \\ {θ}_{buck} = \frac{2 {F}_{cr} {r}_{1}}{{k}_{θ}} = \frac{{r}_{1} {π}^{2} I}{L ( 4 I + {Ar}_{1}^{2} )} . & ( 16 )\end{matrix}$$

Similarly, the limit to blocked moment and free deflection imposed by fracture is derived by relating the maximum bending stress in the beam to the moment, then substituting the fracture stress into Equation (14):

$$\begin{matrix}{M}_{frac} = \frac{{σ}_{frac} w}{2 I} & ( 17 ) \\ {θ}_{frac} = \frac{LI {σ}_{f}}{Ew ( 4 I + {Ar}_{1}^{2} )} . & ( 18 )\end{matrix}$$

The closed form solution for the temperature distribution in the beam 10 assumes that the material properties are all independent of temperature and position. In reality, the thermal conductivity of silicon, thermal conductivity of air, and thermal expansion coefficient of silicon all vary with temperature. For the model to accurately predict device deflections, each of these variations are considered. This is accomplished by an iterative solution of the finite difference version of Equation (5), in which the properties are updated at each step and each location. The thermal conductivity of silicon and thermal expansion coefficient of silicon have been previously approximated as:

$$\begin{matrix} {k}_{s} ( T ) = {e}^{- 1.28 lnT + 12.88} [ W / mK ] & ( 19 ) \\ α ( T ) = 3.725 \times {10}^{- 6} ( 1 - {e}^{- 5.88 \times {10}^{- 3} ( T - 124 )} ) + 5.548 \times {10}^{- 10} T [ {K}^{- 1} ] & ( 20 )\end{matrix}$$

Using previously determined temperature dependent thermal conductivity of air values, a second order polynomial fit is applied over the range of 100K to 950K. Over this range the relationship may be approximated within 1% error as:

nite difference version of Equation (5) is written as:

$$\frac{{T}_{i + 1} + {T}_{i - 1} - 2 {T}_{i}}{{( Δ x )}^{2}} - \frac{{Sk}_{a}}{{k}_{s} gh} {T}_{i} = - \frac{{J}^{2} ρ}{{k}_{s}} - \frac{{Sk}_{a}}{{k}_{s} gh} {T}_{∞} . \qquad ( 22 )$$

Equation (18) is solved using the well-known matrix inversion technique with the material properties updated at each element based on the temperature calculated for that element in the previous iteration. The first iteration assumes a uniform temperature of 298K for these calculations. The system is assumed to converge when the maximum temperature change of any element is less than 1×10⁻³ K. Convergence is typically achieved in six to eight iterations. The thermal expansion of the beam is then calculated using the trapezoidal rule to numerically evaluate the integral in Equation (9), with a calculated for each element. The actuator moment and free rotation angle are then calculated using Equations (10) and (14).

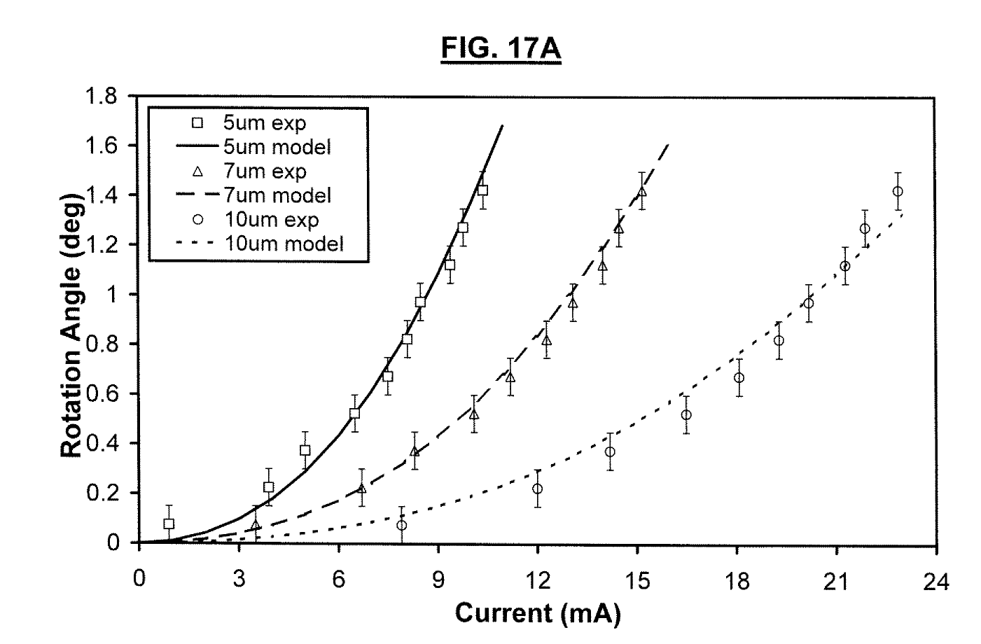

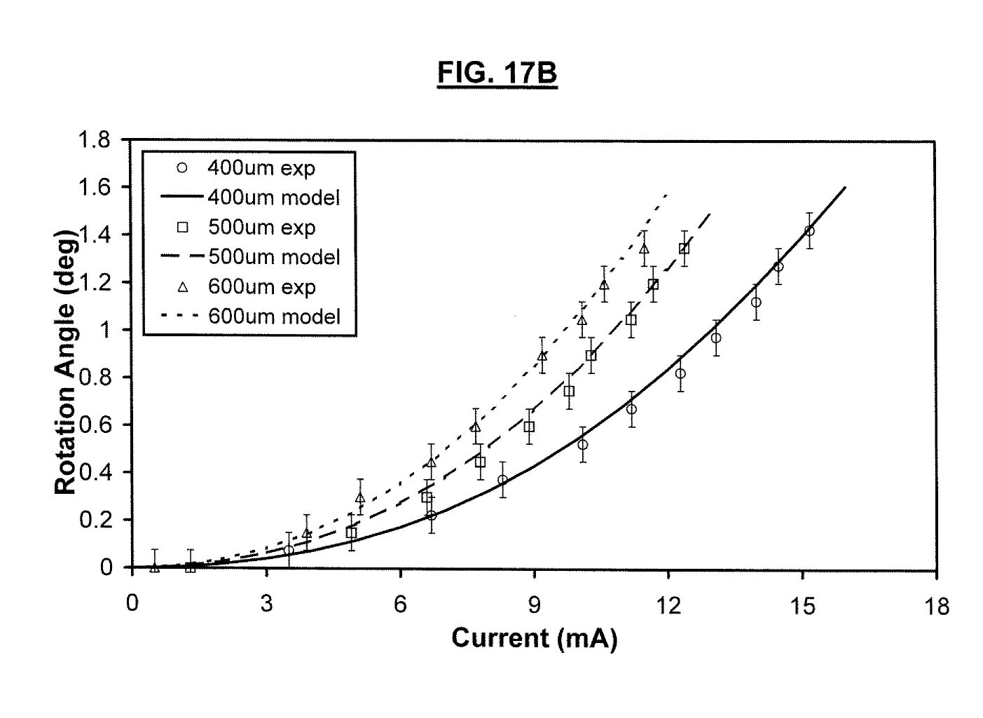

Thermal actuators are current-driven rather than voltage-driven devices, so the actuator free deflection is measured as a function of applied current (FIGS. 17A and 17B). The deflection is measured using the angular Vernier scale, which has gradations of 0.15 degrees. The error in the measurement is therefore estimated as ±0.075 degrees. Most of the experimental devices have a small initial deflection before current is applied, in the range of 0 to 0.15 degrees. This is subtracted from the measurements when comparing with the model. The cause of the initial deflection is possibly due to the compressively stressed buried thermal oxide film pushing in on the device anchors. This mechanism is consistent with the fact that the initial deflection is always in the same direction as the deflection induced by thermal expansion.

The electrothermal model is plotted along with the experimental data in FIGS. 17A and 17B. The experimental results deviate most from the model for case when the beam width w is 10 μm. The trends in FIGS. 17A and 17B illustrate that, for a given applied current, actuator rotation angle increases with decreasing beam width and increasing beam length. Both of these trends are connected to decreasing actuator stiffness, so to minimize power and maximize deflection performance for low resisting loads, the actuator stiffness should be low. For the tested devices, the free deflection benefit of a narrower actuator is much larger than the benefit of a longer actuator.

The moment/angular deflection characteristics of the actuators are also examined using a series of test structures which include resisting cantilever springs 12 with various designed spring constants. The angular deflection is measured as a function of current for each actuator/spring combination using the angular Vernier scale. The actuator moment about point P is calculated using the cantilever spring constant and the measured deflection.

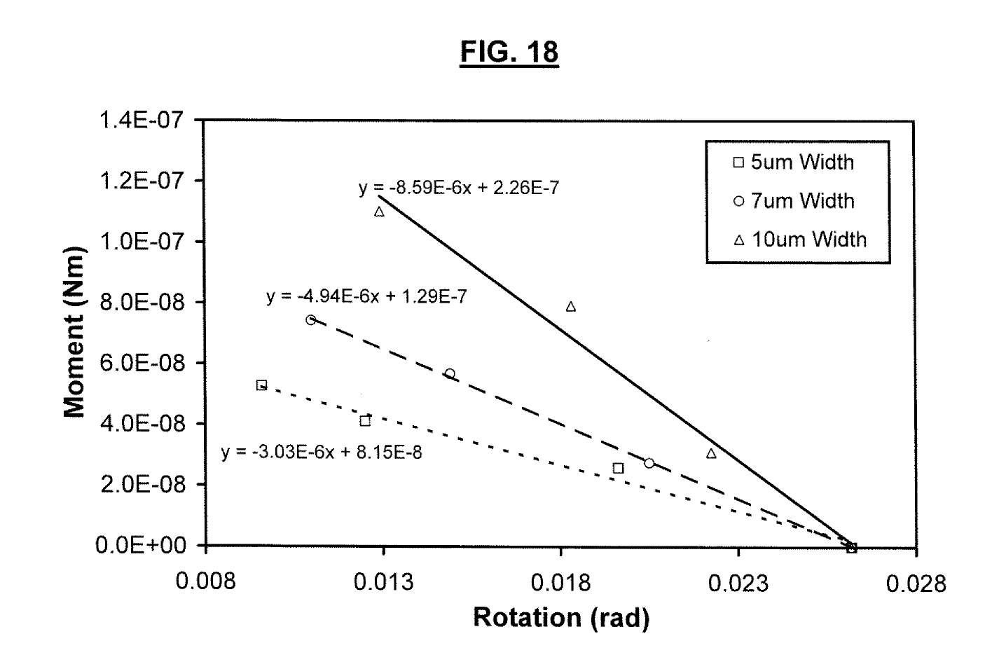

For a single actuator design, measurements at the same applied current are combined to get a moment/rotation angle relationship. FIG. 18 shows three such relationships, for actuators with L=400 μm with various widths. The applied current levels are chosen such that the free deflection of each of the three actuators is the same. Linear trendlines for each actuator configuration are plotted with the data, and the trendline equations are displayed on the graph as well. The slope of the linear trendline for each actuator beam width w is the torsional spring constant of the actuator 1c-1d, and the y-intercept corresponds to the actuator blocked moment. It can be seen that the actuator stiffness and blocked moment both increase with increasing beamwidth.

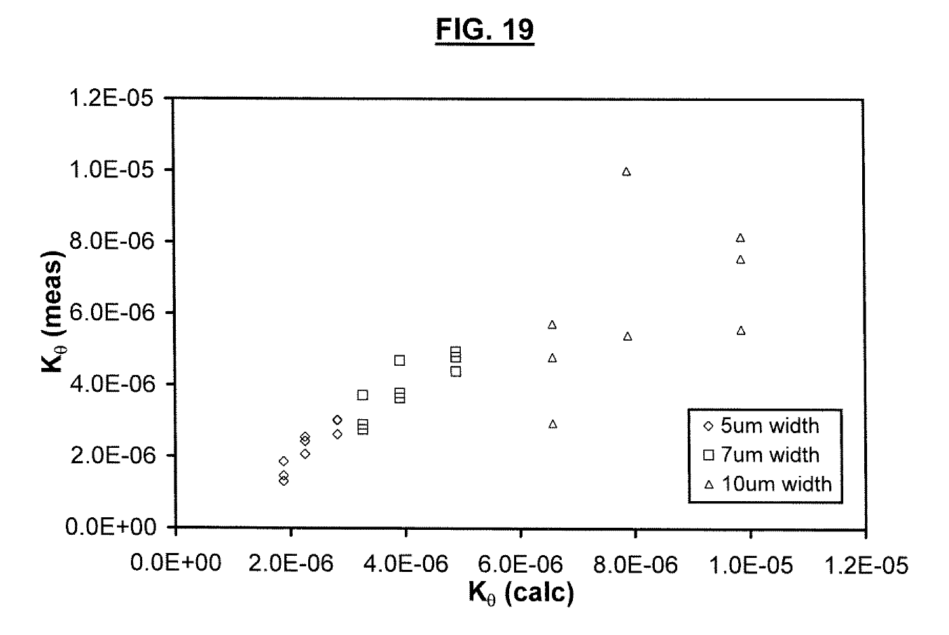

The measured and calculated torsional stiffness coefficients for all of the different beam lengths and widths tested are compared in FIG. 19. For a perfect match between the modeled spring constant and the measured spring constant, the data points should fall on the line y=x. The match is fairly good for the lower spring constant devices, which correspond to the beamwidths of 5 and 7 μm. The beamwidths of 10 μm have far more scatter in the experimental data, with the measured spring constant generally lower than expected. This may result from the fact that the 10 μm-wide beams have collinear edges since r₁ is equal to exactly one-half of the beam width. Therefore, some fraction of the axial force serves only to compress the beam, and generates no moment.

Many applications for MEMS actuators use linear motion rather than rotation as the input. The central yoke 6 allows for near-translational motion at the actuator output for small angular deflections. The linear deflection output is proportional to the yoke length r₂, which for actuators 1c-1d is kept constant at 485 μm. As the yoke length is increased, the free deflection at a given current increases linearly; however, the maximum output force also decreases linearly because the available actuator moment about P remains the same. In other words, the area under the force deflection plot (which represents the feasible operation region of the actuator) remains constant, but the slope of the line can be changed simply by changing the yoke length.

With the above caveat about yoke length, some design criteria for translational output and a comparison to existing purely translational actuators is desirable. Therefore, a translation force-deflection plot (FIG. 19) for the rotational actuators is provided and the development of the actuator spring constant is extended to an equivalent linear spring constant. The linear measurements are conducted on the same test structures as the torsional measurements. The force is obtained by the measured deflection of the resisting cantilever spring combined with the calculated cantilever spring constant. The linear actuator spring constant is given by:

$$\begin{matrix}k = \frac{F}{x} = \frac{M}{{r}_{2}^{2} θ} & ( 23 ) \\ k = \frac{{k}_{θ}}{{r}_{2}^{2}} = \frac{2 E}{{Lr}_{2}^{2}} ( 4 I + {Ar}_{1}^{2} ) . & ( 24 )\end{matrix}$$

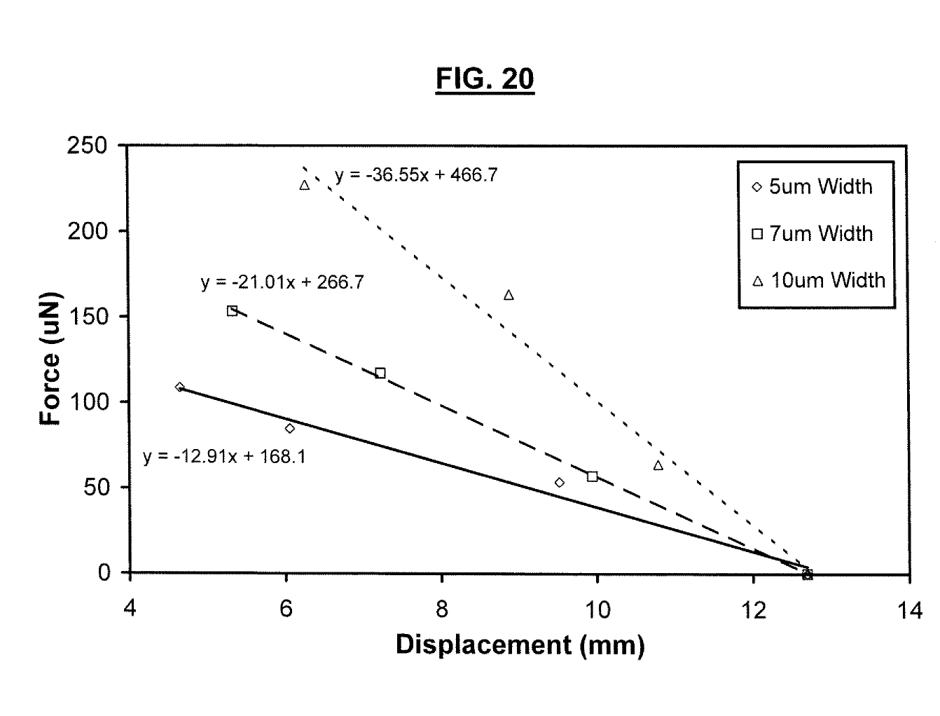

FIG. 20 shows a series of force/deflection profiles for rotational actuators of constant length L=400 μm and varying width. The deflection values shown are the displacement measurements at the actuator output projected onto the x-axis. The slope of the linear trendlines represents an approximate measure of actuator linear stiffness. The actuator stiffness is observed to increase with actuator width. The y-intercept of the trendline is an approximate measure of the actuator blocked force (zero displacement force). It can be seen from the plot that when a wider actuator beam is used, higher forces are possible at the same displacement (yielding larger actuator work). The tradeoff is increased actuator current—the voltage for a given displacement remains relatively constant as the beam is widened.

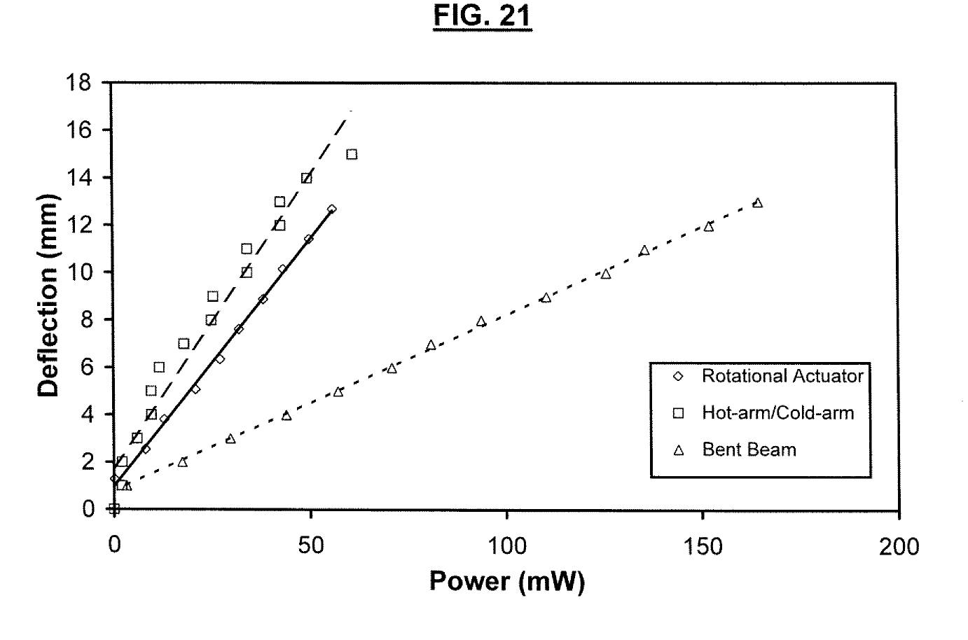

The free deflection of a rotational actuator 1a-1d is also compared with the commonly-used bent-beam and hot arm/cold arm style thermal actuators of similar dimensions in FIG. 21. All of the actuators represented in this graph use 5 μm-wide hot beams, and all are fabricated on SOI wafers with identical 1-3 mΩ-cm resistivity device layers measuring 20 μm thick. The hot arm/cold arm actuator is 1050 μm long, the bent-beam actuator is 1200 μm long, and the rotational actuator is 1000 μm long (L=500 μm) with an amplification beam of r₂=485 μm. The rotational actuator 1a-1d consumes slightly more power than the hot arm/cold arm actuator but only about 36% as much as the bent-beam actuator for the same free deflection.

The rotational actuator 1a-1d can provide far more force than the hot arm/cold arm style actuator, however. The maximum measured force output from the bent-beam actuator design is 1.2 mN at 24.7 mA/18.8V drive, pushing against a spring with a stiffness of 50 N/m. As the current is increased from this point, the actuator beams began to buckle. The maximum force measured with the rotational actuator is 0.23 mN at 15 mA/12V, pushing against a spring with a stiffness of 69.5 N/m. The rotational actuator 1a-1d is therefore a good choice for applications that require large displacements and require more force than a hot arm/cold arm actuator can provide, but not all of the force available with a bent-beam actuator.

As indicated above, in both simulations and testing for other types of thermal actuators, the dominant heat loss mechanism is conduction through the air to the substrate 15, followed by heat loss into the support structures 2, 3. Containing these heat losses can greatly increase the actuator efficiency by increasing the equilibrium beam temperature for the same applied current. The heat loss through the air into the substrate 15 is eliminated by operating the actuators 1a-1d under vacuum. The electrothermal model is modified for the vacuum case by eliminating the term representing the heat loss through the air into the substrate 15. Equation (5) then becomes:

$${k}_{s} \frac{{d}^{2} T ( x )}{d {x}^{2}} + {J}^{2} ρ = 0. \qquad ( 25 )$$

The solution to Equation (16) is found by separating variables and applying the boundary conditions T=T_{∞} at x=0, L:

$$T ( x ) = - \frac{{J}^{2} ρ}{2 {k}_{s}} {x}^{2} + \frac{{J}^{2} ρ L}{{k}_{s}} x + {T}_{∞} . \qquad ( 26 )$$

For comparison, the temperature profiles for an actuator with L=400 μm, w=5 μm are shown in FIG. 22. The resulting thermal expansion and free angular deflection in each actuator beam under vacuum become:

$$\begin{matrix}δ = \frac{α {J}^{2} ρ}{{k}_{s}} ( \frac{{L}^{3}}{6} ) & ( 27 ) \\ θ = {r}_{1} \frac{2 {E}^{2} A α {J}^{2} ρ L}{3 {k}_{s}} ( 4 I + {Ar}_{1}^{2} ) . & ( 28 )\end{matrix}$$

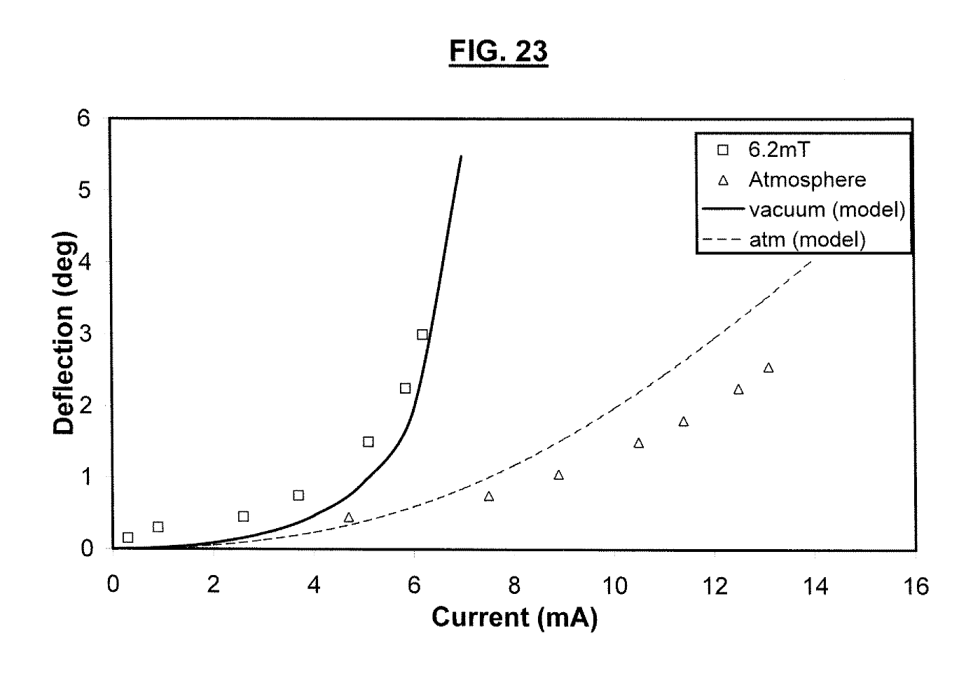

An actuator with the same parameters used to construct FIG. 22 is tested both in vacuum and atmospheric (ambient) conditions. The pressure during vacuum testing varies between 5.9 mT and 6.5 mT. The results are plotted in FIG. 23. For the same free deflection, the actuator required 50% less current and 40% less voltage, consuming 70% less power overall.

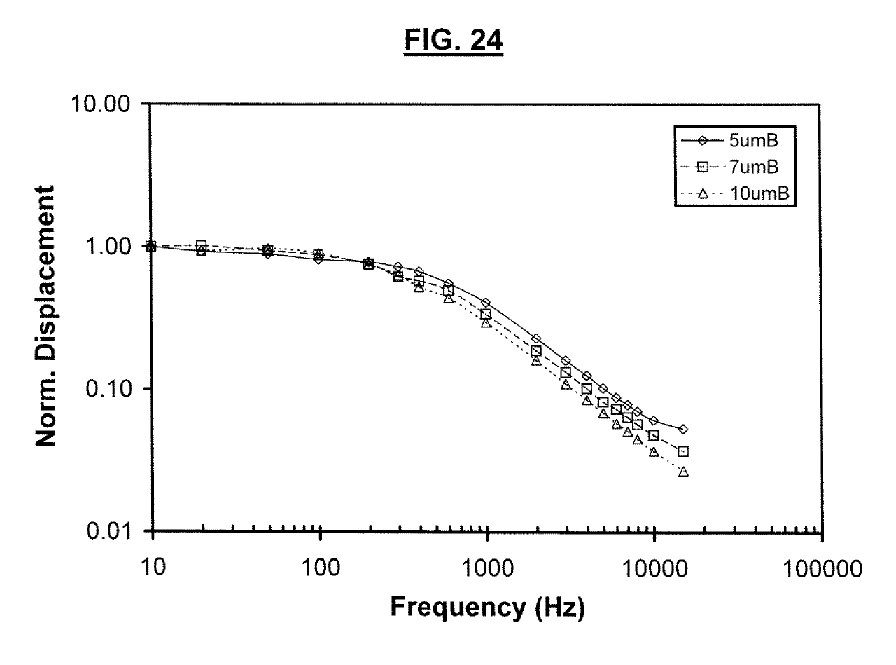

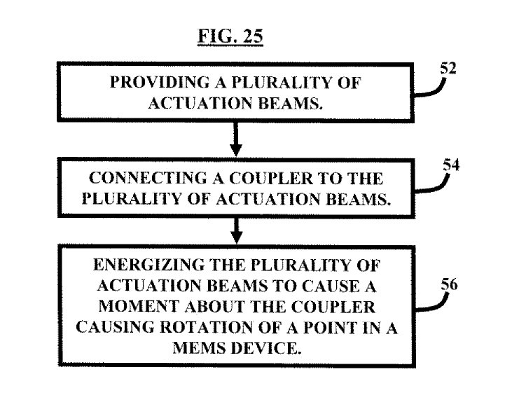

The frequency of operation for thermal actuators is generally limited by the thermal time constant of the system. The rotational offset beam actuator is limited in the same way. The thermal time constant of the actuator depends primarily on the beam width, length, and thickness. Smaller devices have a lower thermal mass and are expected to have a larger cutoff frequency. Frequency response measurements are performed using a laser Doppler vibrometer while driving the device with a square wave input signal. The normalized frequency response in air is shown in FIG. 24. The measurements shown correspond to actuators with L=400 μm. The cutoff frequencies extrapolated from this data are about 350, 285, and 270 Hz for the 5 μm-wide, 7 μm-wide, and 10 μm-wide actuators, respectively.

FIG. 25, with reference to FIGS. 1 through 24, is a flow diagram illustrating a method of providing rotational actuation of a microelectromechanical system (MEMS) device, according to an embodiment herein, wherein the method comprises providing (52) a plurality of actuation beams 4, 5, 7; connecting (54) a coupler 6 to the plurality of actuation beams 4, 5, 7 wherein the coupler 6 is connected to each individual actuation beam 4, 5, 7 at a position where connection of the coupler 6 to other actuation beams 4, 5, 7 causes a longitudinal axis of each actuation beam 4, 5, 7 to be offset with respect to one another; and energizing (56) the plurality of actuation beams 4, 5, 7 to cause a moment about the coupler 6 causing rotation of a point in the MEMS device 1a-1d. The method may further comprise connecting an amplification beam 10 to the coupler 6 such that the longitudinal axis of the amplification beam 10 is substantially perpendicular to the longitudinal axes of the plurality of actuation beams 4, 5, 7. Also, the method may further comprise connecting a resistant spring member 12 to the amplification beam 10.

The longitudinal axes of the plurality of actuation beams 4, 5, 7 may be substantially parallel to one another. Moreover, the plurality of actuation beams 4, 5, 7 are lengthened or shortened to generate the moment about the coupler 6 causing the amplification beam 10 to rotate. Additionally, the plurality of actuation beams 4, 5, 7 may comprise any of thermal-sensitive materials that are induced to lengthen or shorten the plurality of actuation beams 4, 5, 7 and piezoelectric materials that are induced to lengthen or shorten the plurality of actuation beams 4, 5, 7. The method may further comprise attaching the plurality of actuation beams 4, 5, 7 to support structures 2, 3. Furthermore, the rotation may provide reset latching for a microelectromechanical system (MEMS) sensor (not shown). Also, the plurality of actuation beams may comprise any of microgrippers and microtweezers (not shown). Moreover, the plurality of actuation beams 4, 5, 7 may be electrically conductive. An offset amount between the longitudinal axes of the plurality of actuation beams 4, 5, 7 may be greater than a width of each individual actuation beam 4, 5, 7. Alternatively, an offset amount between the longitudinal axes of the plurality of actuation beams 4, 5, 7 may be less than a width of each individual actuation beam 4, 5, 7.

The embodiments herein solve the problem of high voltages required for MEMS actuators, especially when large displacements are required. Typical electrostatic actuators require more than 50 volts for actuation, and typical piezoelectric actuators require 10-20V for actuation. The thermal actuator 1 produces more than 20 μm of displacement at less than 3V, 7 mA, so it can be used in a remote sensor node with a lithium battery and not require any voltage amplification circuitry.

The embodiments herein can be used to reset a latching MEMS sensor, such as the shock sensor of U.S. Pat. No. 6,737,979, the contents of which, in its entirety, is herein incorporated by reference. The latching feature allows the sensor to monitor shock continuously with no power supplied, but in order to reuse the device a rest actuator is included to unlatch it. The reset actuator must typically supply >20 μm of displacement. Power is inherently scarce in systems which must use this type of device, or they would incorporate a more precise, powered accelerometer. Thus, the low-voltage, low current actuator provided by the embodiments herein can be advantageously used for the reset function of a latching sensor.

Many other applications of the embodiments herein in MEMS are also possible including, essentially, any device that requires rotational or translational actuation. The thermal devices can be made of low-resistivity silicon or polysilicon. Additionally, the actuators 1a-1d may be used in inkjet printheads, and provides large force and large displacements simultaneously while drawing relatively small amounts of current and voltage.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A rotational actuator comprising:
more than two actuation beams having substantially parallel longitudinal axes;
each actuation beam having an offset longitudinal axis with respect to every other beam;
said beam being capable of being lengthened or shortened to cause a moment;
a plurality of coupling joints connecting said actuation beams to one another, wherein said coupling joints are connected to each individual actuation beam at a point longitudinally and axially offset from other actuation beams;
whereby said plurality of actuation beams are caused to be lengthened or shortened to create a moment about said coupling joint thus causing rotation about a point in said rotational actuator.

2. The rotational actuator of claim 1, wherein said longitudinal axes of the actuator beams are offset progressively in a common direction.

3. The rotational actuator of claim 2, further comprising an amplification beam that is connected to said coupling joints such that the longitudinal axis of said amplification beam is substantially perpendicular to said longitudinal axes of said plurality of all other actuation beams.

4. The rotational actuator of claim 1, wherein the axes of said actuation beams are offset in alternating positive and negative directions so as to cause rotations of the coupling joints at alternating positive and negative angles.

5. The rotational actuator of claim 3, wherein said amplification beam is connected to said coupling joints such that the longitudinal axis of said amplification beam is substantially perpendicular to said longitudinal axes of said plurality of actuation beams.

6. The rotational actuator of claim 4, wherein the amplification beams are formed to create the function of a microgripper or microtweezer type of device.

7. The rotational actuator of claim 5, wherein the microgrippers/microtweezers close upon application of an actuating signal.

8. The rotational actuator of claim 5, wherein the microgrippers/microtweezers open upon application of an actuating signal.

9. A method of providing rotational actuation of a microelectromechanical system (MEMS) device, said method comprising:
providing a plurality of actuation beams;
connecting a coupler to said plurality of actuation beams, wherein said coupler is connected to each individual actuation beam at a position where connection of said coupler to other actuation beams causes a longitudinal axis of each actuation beam to be offset with respect to one another; and
energizing said plurality of actuation beams to cause a moment about said coupler causing rotation of a point in said MEMS device.

10. The method of claim 9, further comprising connecting an amplification beam to said coupler such that the longitudinal axis of said amplification beam is substantially perpendicular to said longitudinal axes of said plurality of actuation beams.

11. The method of claim 10, further comprising connecting a resistant spring member to said amplification beam.

12. The method of claim 9, wherein the said plurality of actuation beams may be substantially parallel to one another in the longitudinal axes and angled to one another with respect to the exterior angles of regular polygons.

13. The method of claim 9, wherein said plurality of actuation beams are lengthened or shortened to generate said moment about said coupler causing said amplification beam to rotate.

14. The method of claim 13, wherein said plurality of actuation beams comprise any of thermal-sensitive materials that are induced to lengthen or shorten said plurality of actuation beams and piezoelectric materials that are induced to lengthen or shorten said plurality of actuation beams.

15. The method of claim 9, further comprising attaching said plurality of actuation beams to support structures.

16. The method of claim 9, wherein said rotation provides reset latching for a microelectromechanical system (MEMS) sensor.

17. The method of claim 9, wherein said plurality of actuation beams comprise any of microgrippers and microtweezers.

18. The method of claim 9, wherein said plurality of actuation beams are piezoelectric or electrically conductive for the thermal-sensitive materials.

19. The method of claim 9, wherein an offset amount between the longitudinal axes of said plurality of actuation beams is greater than a width of each individual actuation beam.

20. The method of claim 9, wherein an offset amount between the longitudinal axes of said plurality of actuation beams is less than a width of each individual actuation beam.

21. A microelectromechanical system (MEMS) device comprising:
at least two anchored actuation beams arranged in series with one another, wherein each beam comprises an offset longitudinal axis with respect to other actuation beams;
a coupling joint that connects said at least two actuation beams to one another in an offset configuration;
a cantilevered amplification beam operatively connected to said coupling joint, wherein the longitudinal axis of the amplification beam is substantially perpendicular to the longitudinal axes of said at least two actuation beams; and
a resistant spring member operatively connected to the amplification beam, wherein said at least two actuation beams are lengthened or shortened to cause a moment about said coupling joint causing rotation of the amplification beam, and wherein said at least two actuation beams comprise any of thermal-sensitive materials that are induced to lengthen or shorten said at least two actuation beams and piezoelectric materials that are induced to lengthen or shorten said at least two actuation beams.

22. A method of fabricating a microelectromechanical system (MEMS) device comprising:
providing a silicon-on-insulator wafer,
depositing a thin layer of plasma enhanced chemical vapor deposition silicon dioxide,
sputtering a seed layer of titanium,
sputtering a platinum layer on top of the titanium to act as a bottom electrode,
depositing a piezoelectric film on said silicon-on-insulator wafer,
metalizing a top electrode,
exposing a bottom metal,
patterning a device silicon layer by deep reactive ion etching so as to delineate the beams from the contact pads,
removing the exposed buried oxide by means of reactive etching,
spinning a thick photoresist for placement on the wafer to fill the trenches around the devices and protect sidewalls of the devices, and
performing an etch with buffered hydrofluoric oxide to remove buried oxide from the bottom of beams, and
ashing the wafer in oxygen plasma to remove any residue and particulates.

23. The method of claim 22 wherein exposing a bottom metal electrode by means of a PZT wet etch.

24. The method of claim 22 wherein said top electrode is formed by patterning and ion milling a top metal layer.
